(19) United States
(12) Patent Application Publication
(10) Pub. No.: US 2026/0044195 A1
(43) Pub. Date: Feb. 12, 2026

(54) POWER CYCLING CONTROL FOR SERVER TRAY SYSTEMS AND CIRCUITRY

(71) Applicant: Nvidia Corporation, Santa Clara, CA (US)

(72) Inventors: Jeremy Baus, Raleigh, NC (US); Kyle Patrick Roberts, Raleigh, NC (US); James David Patterson, Raleigh, NC (US); Vincent William Michna, Houston, TX (US); Ivan Ricardo Zapata, Apex, NC (US); Anthony David Gamerman, Apex, NC (US); Steven Hart Penna, Wake Forest, NC (US); Kushan Rameshbhai Patel, Cary, NC (US); Ryan Albright, Beaverton, OR (US); Elad Mentovich, Tel Aviv (IL)

(21) Appl. No.: 18/800,719

(22) Filed: Aug. 12, 2024

(51) Int. Cl. G06F 1/26

(52) U.S. Cl. CPC G06F 1/26

(57) ABSTRACT

Approaches presented herein provide for the management of power supplied to server trays, such as allowing for power cycling of individual server trays in a server rack powered by a DC busbar. In at least one embodiment, a timer circuit may be triggered by a power cycling command to prevent power from a power source, such as a busbar, to be provided to processing circuitry within a server tray of a server rack, except the timer circuit. The power can be caused be no longer available to the processing circuitry, ending operation of logical operations of the processing circuitry. After a period of time, the timer circuit can generate a signal to cause the power from the power source to be made available to the processing circuitry, allowing for resumed operation. At least a minimum amount of capacitance may be discharged from the processing circuitry during the period of time.

### BACKGROUND

As server systems move toward rack-scale solutions with many server trays installed into a single rack, power to the server trays can be provided via a connection to a busbar DC power source instead of an AC power source. The busbar DC power sources can provide power continuously to all of the server trays. While AC powered servers may include a Power Distribution Unit (PDU) which could be accessed to power cycle individual servers remotely if required, the busbar DC power source and all connected servers are powered on or off together. Due to the continuously provided power to all connected servers, it can be difficult to perform operations including firmware updates, server hang resets, and other conditions where a single server should be power cycled, while maintaining continuous operation of all other servers powered from the same busbar.

### BRIEF DESCRIPTION OF THE DRAWINGS

Various embodiments in accordance with the present disclosure will be described with reference to the drawings, in which:

FIG. 1 illustrates components of a server system to perform power cycling functions, according to at least one embodiment;

FIG. 2 illustrates an example system for managing one or more power cycle functions using a timer-based circuit, according to at least one embodiment;

FIG. 3 illustrates an example timer circuit to perform power cycling functions for a server tray or circuitry within a server tray, according to at least one embodiment;

FIG. 4 illustrates an example process that can be performed to power cycle a server tray of a DC busbar powered server, according to at least one embodiment;

FIG. 5 illustrates an example process that can be performed to determine whether power has been re-established to a server tray, according to at least one embodiment;

FIG. 6 illustrates an example data center system, according to at least one embodiment;

FIG. 7 is a block diagram illustrating a computer system, according to at least one embodiment;

FIG. 8 is a block diagram illustrating a computer system, according to at least one embodiment;

FIG. 9 illustrates a computer system, according to at least one embodiment;

FIG. 10 illustrates a computer system, according to at least one embodiment;

FIG. 11 illustrates exemplary integrated circuits and associated graphics processors, according to at least one embodiment;

FIGS. 12A and 12B illustrate exemplary integrated circuits and associated graphics processors, according to at least one embodiment;

FIG. 13 illustrates a computer system, according to at least one embodiment;

FIG. 14A illustrates a parallel processor, according to at least one embodiment;

FIG. 14B illustrates a partition unit, according to at least one embodiment; and

FIG. 15 illustrates at least portions of a graphics processor, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches in accordance with various illustrative embodiments provide for the management of power supplied to server trays, such as allowing for power cycling of logic in the trays. In particular, at least one embodiment a server tray may have power always provided through the use of, for example, a DC busbar. A timer-based circuit may be used which can be used for performing power cycling of the server trays or circuitry of the power trays. A power cycle instruction may be received, triggering the timer-based circuit. In response to the trigger of the timer-based circuit, all power from the power busbar to the circuitry of the tray can be cut. The timer-based circuit may be the only component of a server tray that continues to receive power during the power cycling. With no power available to any of the logic on the server tray other than the timer-based circuit, this logic cannot receive and process an external command to re-establish power. After a determined amount of time, the timer-based circuit can send a signal to a power supply, power management controller, or other appropriate component to cause power to be re-established for components of the tray. The amount of time may be sufficient to discharge the capacitors, power supplies, and other components, as required by the server tray, or individual circuitry. The amount of time the timer-based circuit is delayed may be adjusted prior to the power cycle, or may be extended before or during the power cycle.

A server tray in at least one embodiment may allow for staggered power cycling, such as for different busbars that can be re-enabled in sequence. A logic device can be used to determine whether power has been successfully re-established for all relevant components of a server tray, and if not can trigger another power cycling. The logic device may also determine whether power has been successfully re-established to specific components, or whether power has been successfully re-established to components according to a specific sequence. The power cycle instruction may be received from a system external to the server or tray, a component of the tray circuitry, or as a mechanical signal generated in response to operation of a physical input or activator. The server or server tray may include a power management system to perform related tasks, such as receive the power cycle instruction, trigger the timer-based circuit, or end the delivery of the power from the busbar to the circuitry. The timer-based circuit may generate multiple signals to allow power to be provided to different portions of the circuitry at various times.

Variations of this and other such functionality can be used as well within the scope of the various embodiments as would be apparent to one of ordinary skill in the art of the teachings and suggestions contained herein.

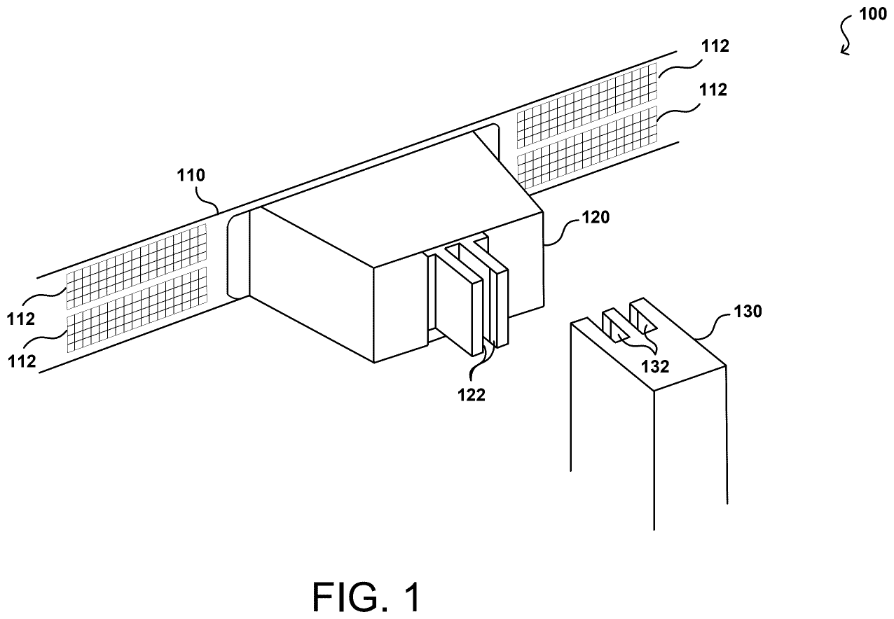

FIG. 1 illustrates components of an example server system 100 to perform power cycling functions that can be used in accordance with at least one embodiment. In this example, the server system 100 includes a server tray assembly 110, which includes a number of data ports 112 and a power receptacle 120. The server tray assembly 110 may be one of multiple server trays installed into a server rack and may be part of a data center infrastructure. The server tray assembly 110 may have data transferred using the data ports 112. The data ports 112 may interface with a data transfer device, such as a data cable to enable storage or processing of data using on the server tray assembly 110. The power receptacle 120 may be used to receive power to circuitry of the server tray assembly 110 and may include receptacle contacts 122 which transfer the electricity as power to circuitry of the server tray assembly 110. The server system 100 may also include a power source 130, such as a DC busbar specified by the Open Compute Project (OCP) for server racks. The power source 130 may be used to send power to circuitry of the server tray assembly 110 and may include source contacts 122 which transfer the electricity as power to receptacle contacts 122 of the power receptacle 120. The power source 130 may be installed in a server rack and may provide power to multiple server trays. The power source 130 may provide continuous power to the server tray assembly 110 while the power source 130 is operating, or be “always on.” The server tray assembly 110 may be physically disconnected from the power source 130 to prevent power from being provided to the server tray assembly 110 via the power source 130 by removing the server tray assembly 110 from the server rack.

In an embodiment, the server tray assembly 110 of the server system 100 may include a timer-based circuit to prevent power from being provided to the server tray assembly 110 via the power source 130 without removing the server tray assembly 110 from the server rack. After receiving instructions to prevent power to the server tray assembly 110, the timer-based circuit may be the only part of the server tray assembly 110 circuitry to still receive power. After a specified period of time, the timer-based circuit may allow power to be provided from the server tray assembly 110 via the power source 130. The timer-based circuit may be used to power cycle the individual server trays assemblies 110 powered via to the “always on” power source 130 in the server system 100, while maintaining a physical connection between the server tray assembly 110 via and power source 130, as well as maintaining continuous operation of all other server trays powered from the same power source 130. The power source 130 may be powered down to prevent power delivery to all server trays on the server rack, which may power cycle the timer-based circuit. The timer-based circuit may manage one or more power cycle function and account for events or states including system hang, host level control, management level control, external control, or other factors. In an embodiment, the timer-based circuit may not include a battery or a real-time clock to remain power or indicate the power should be re-established to the circuitry. In another embodiment, the timer-based circuit may include a battery or a real-time clock, such as for redundancy.

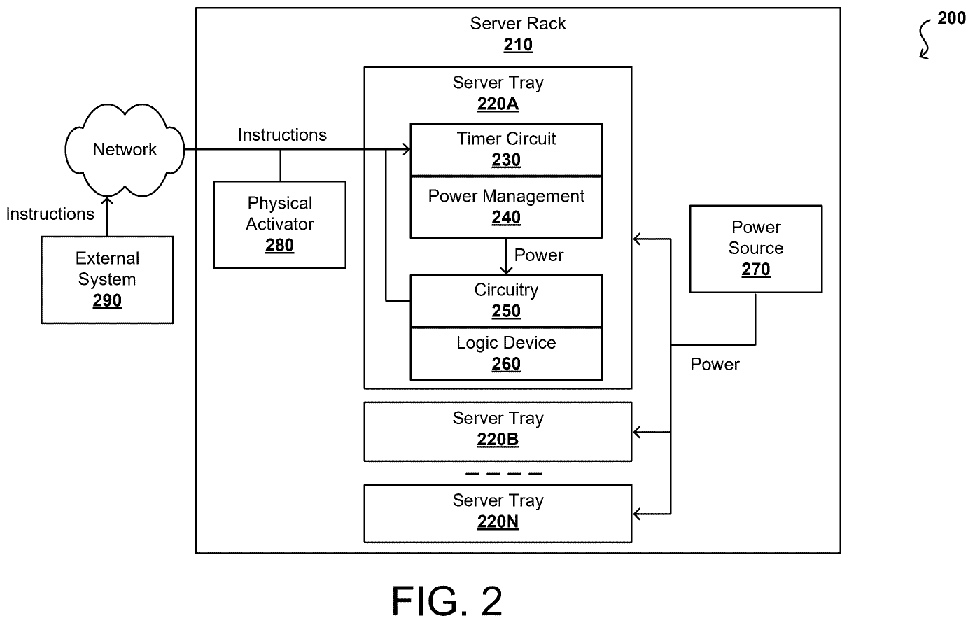

FIG. 2 illustrates an example system 200 for managing one or more power cycle functions using a timer-based circuit in accordance with at least one embodiment. In this example, the system 200 includes a server rack 210 installed with one or more server tray(s) 220A-220N (e.g., 220A, 220B, through 220N-1, and 220N) as shown in FIG. 2, which may provide data processing, storage, or other suitable services. In at least one embodiment, a number of server trays can vary. The server rack 210 may also include a power source 270, such as a DC busbar, which can continuously provide power to one or more of the server tray(s) 220A-220N. One or more of the server tray(s) 220A-220N may include a timer circuit 230, such as a hot swap controller, which may act as a gate between the power source 270 and the rest of the server tray, such as circuitry 250 of the server tray(s) 220A-220N. The circuitry 250 may be able to perform one or more logical operations. Since power to the rest of the circuitry 250 has been cut off, the de-powered circuitry cannot perform logical operations to provide instructions to a gate re-establish power. Therefore, the timer circuit 230 acting as a gate relies on a specified time window to indicate that power should be re-established to the rest of the circuitry 250.

Power cycling all of the control logic on the circuitry 250 allows correcting errors on any of the control logic, which could be the reason the power cycle was needed. The timer circuit 230 may be at least partially independent from the rest of the circuitry 250, such as to allow the timer circuit 230 to remain powered when the circuitry 250 is de-powered during a power cycle. The activation of the timer circuit 230 after the specified time period has completed, such as to generates a signal to cause power from the power source 270 to be made available to allow for resumed operation of the circuitry 250, may be an analog action. The time period for the delay to re-establish power to the server tray 220A may be sufficient to allow for discharge of at least a minimum amount of capacitance of the circuitry 250. The time period for the delay to re-establish power to the server tray 220A may be set prior to beginning a power cycle or may be determined during the power cycle, such as based on the amount of time required to discharge of an amount of capacitance, a check performed by the circuitry 250, or other information. The timer circuit 230 may send instructions as multiple commands or signals to allow for the power from the power source 270 to be made available to different portions of the circuitry 250 at different points in time.

The server tray 220A may be power cycled by receiving instructions from the circuitry 250 of the server tray 220A to cut off power between the power source 270 and the rest of the circuitry 250. The server tray 220A may be power cycled by gaining remote access to the server tray 220A using an external system 290 through a network connected to the server tray 220A and issuing a command or instruction from circuitry 250 of the server tray 220A to cut off power between the power source 270 and the rest of the circuitry 250. The server tray 220A may be power cycled by receiving instructions from a physical activator 208, such as a control, button, or control node, locally positioned with the server tray 220A or server rack 210. A physical activator 208 may be needed to initiate a power cycle when other options are not available, such as when the server tray 220A is inaccessible, hung up, or logging into the server tray 220A is not possible. In an embodiment, the timer circuit 230 may be powered off along with the rest of the circuitry 250. The timer circuit 230 may be turned off, and then after a period of time the timer circuit 230 may power on and then allow power to be provided to the rest of the server tray 220A. In an embodiment, the server tray 220A may also be removed from the server rack 210 to be disconnected from the power source 270.

The server tray(s) 220A-220N may include a power management component 240 to manage power functions. In an embodiment, power management component 240 may receive the power cycling command, trigger the timer circuit 230, or cause the power from the power source 270 to no longer be available to the circuitry 250. The power management component 240 may be part of the timer circuit 230, so that the power management component 240 remains powered when the circuitry 250 is de-powered during a power cycle. The server tray(s) 220A-220N may include a logic device 260 check whether power has been re-established to the circuitry 250 after instructions have been received to the re-establish power. If the logic device 260 determines that power has been re-established to the circuitry 250 then the start-up or power cycle process for the server may continue. If the logic device 260 determines that power has not been re-established to the circuitry 250 then the logic device may generate instructions or commands to prevent power to the circuitry, or restart the power cycle. One or more of the timer circuit 230, power management component 240, and logic device 260 may be a part of the circuitry 250 of the server tray. Any number of control options can be introduced the timer circuit 230 to provide different options to ensure that a server tray can successfully power cycle without having to power down an entire server rack.

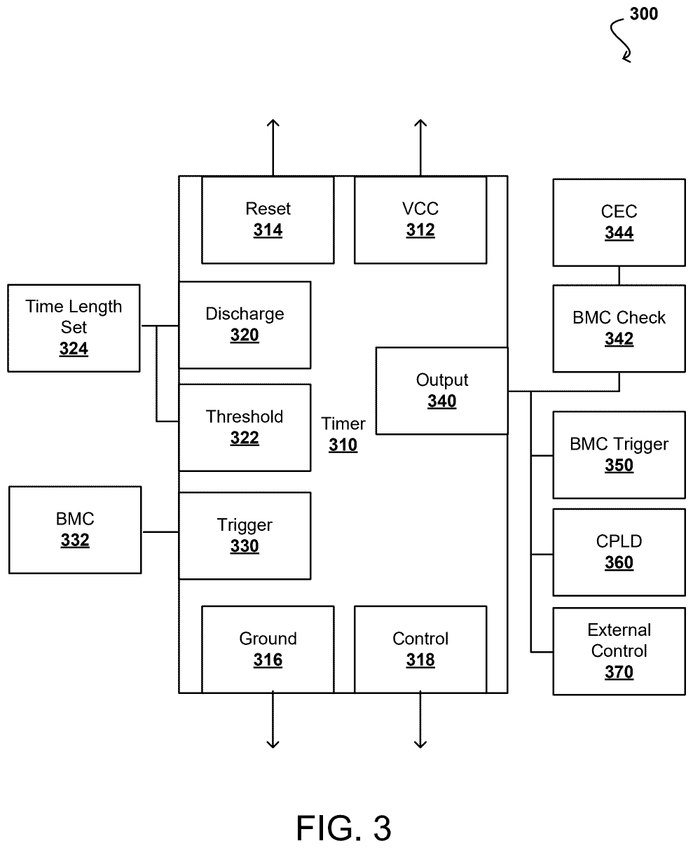

FIG. 3 illustrates an example timer circuit 300 to perform power cycling functions for a server tray or circuitry within a server tray that can be used in accordance with at least one embodiment. In this example, the timer circuit 300 includes a timer 310 to manage power cycling functions, such as for server trays or circuitry within server trays, by providing commands or instructions after a specified period of time after power has been caused to not be available to server trays or circuitry within server trays. The timer 310 may remain powered from a power source or domain that remains powered when the remaining circuitry of the server tray is powered off during the set time period. In an embodiment, the timer 310 may be an integrated chip, such as a microchip, computer chip, or other device. In another embodiment, the timer 310 may be part of an integrated chip. The timer 310 may be built into a microcontroller reset chip, which is held in reset until the set time period is completed. The timer 310 may be held in reset during the set time period needed for the timer 310 to power up, load configurations, and processor code has fully loaded. The timer 310 manages the delivery of power from the power supply to the circuitry, such as to hold power supplies off and re-establish power. Multiple timers 310 may be combined, such as chained, to provide for more rigorous or structured power cycling, such as re-enabling different rails of a circuit in sequence.

The timer circuit 310 may include a supply voltage terminal 312, a reset terminal 314, a ground terminal 316, and a control voltage terminal 318. The supply voltage terminal (VCC) 312 may be used for powered supply monitoring or a voltage level, with respect to the ground terminal 316, that requires monitoring. The reset terminal 314 may be used to output an alternative voltage while VCC 312 is below the reset voltage threshold. Once the VCC 312 returns to a high level, the server tray will remain in reset for the duration of the delay time. A negative pulse applied to the reset terminal 314 may disable or reset the timer 310. The ground terminal 316, such as a circuit ground, may provide a negative reference for the analog input voltage. The control terminal voltage 318 may provide access to the internal voltage divider to control the threshold terminal 322 level and trigger terminal level 330. The control terminal voltage 318 may determine the pulse width of output terminal 340 waveform. An external voltage applied to the control terminal voltage 318 can also be used to modulate the output terminal 340 waveform.

The timer circuit 310 may also include a discharge terminal 320 and a threshold terminal 322. The discharge terminal 320 may be an open collector output which discharges a capacitor between intervals, such as in phase with the output terminal 340. The threshold terminal 322 may signal when the applied voltage is greater than the voltage at the control terminal 318 to end the timer. The amplitude of voltage applied to the threshold terminal 322 is responsible for the set state of the flip-flop of the timer 310. The discharge terminal 320 and the threshold terminal 322 can be used with the time length set 324 to control the timer length. The time length set 324 may determine auxiliary reset power down timing, or the specified time period of delay after the timer is triggered and before re-establishing power to the circuitry. The time length set 324 may include a resistor and a capacitor, the values of the resistor and capacitor may determine the specified time period, and may be adjusted. The capacitor of the time length set 324 may be discharged when internal flop is in “set” state. The pulse delay generated by the timer 310 to initiate re-introduction of power to the circuitry may be delayed by about 7.5 seconds, 2.5 seconds, 0.001 seconds, 60 seconds, 24 hours, or any other suitable length of time. The time delay or time window may be adjusted, such as in a user setting or user interface. The time windows can be chosen for different systems, such as based on the time needed for the capacitors to discharge, power supplies to discharge, or other reasons. The time window required to discharge at least a minimum amount of capacitance of the circuitry can be different for each server tray, and in some embodiments may be calculated at least in part. The amount of time to delay the re-establishment of power may be based in part on the amount of capacitance in a circuit, the how much power a circuit consumes, the time required to bleed circuit voltage down to a level that corresponds to a functional reset, a buffer, or other considerations. In an example, the circuit of a server tray may need a 3-volt rail to bleed below 1-volt to guarantee a full power cycle.

The timer circuit 310 may also include a trigger terminal 330 to initiate the pulse when voltage is below a certain amount, such as one third of the VCC terminal 312 voltage, by transitioning the flip-flop from set to reset. The output of the output terminal 340 may depend on the amplitude of the external trigger pulse applied to the trigger terminal 330. Once the trigger terminal 330 has been activated, the trigger terminal 330 may not be reactivated until the set time period is completed. A baseboard management controller (BMC) 332 connected with trigger terminal 330 may drive a general-purpose output (GPO) circuit high to initialize the auxiliary reset. The BMC 332 may be a processor to remote monitor and manage a host system. A pulldown resistor in connection with the BMC 332 may pull the GPO back when the BMC 332 loses power, which resets the trigger 330. When the GPO is driven high by BMC 332, trigger terminal 330 input to the timer 310 may go low, which can force internal flop to “set” state, which can drive the output terminal 340 on, or to 1.

The timer circuit 310 may also include the output terminal 340 which provides a pulsating output, or outputs a driven waveform. The output of the output terminal 340 from the internal flop of the timer 310 remains in “set” state until the resistor and capacitor of time length set 324 discharges to a level below the VCC terminal voltage, such as two thirds. The flop may then be reset, and the output returns down, such as to zero. The output terminal 340 may provide the waveform to a BMC check 342, a central electronics complex (CEC) 344, a BMC trigger 350, a complex programmable logic device (CPLD) 360, and an external control 370. The CEC 344 may ensure proper power down sequences are performed, such as for BMC 332. The BMC check 342 may ensure that the rails of BMC 332 are powered down before the CEC 344. The rails of BMC 332 may need to be powered down before the CEC 344 because the CEC 344 should remain powered until the rails of BMC 332 are powered down to ensure proper BMC 332 power down sequence. The BMC check 342 may be a transistor.

The BMC trigger 350 may connect to a manual reset terminal of a reset controller which triggers power down of, or preventing power to, the rails of BMC 332. The CPLD 360 may be a logic device used for remote software control. The CPLD 360 may be used for watchdog capability, such as to check whether power has been successfully re-established to the circuitry or portions of the circuitry. If power has been successfully re-established the CPLD 360 may trigger another power cycling. The watchdog capability may be the first or one of the components to be re-established with power. The watchdog capability may start a timer at intervals to check if other components are powered on after a reset. If the check is failed, the watchdog capability may require another power cycle be started. The external control 370 may be used for remote software control, such as from an external system. The external control 370 may be used for watchdog capability, such as to check whether power has been successfully re-established to the circuitry or portions of the circuitry. In an embodiment, the timer may be triggered to start a power cycle based on a mechanical signal generated in response to manual activation of a physical activator, such as a button, external relay, or external node, connected to the server. In an example, the delay in re-establishing power may be determined based on the length of time the button is pressed or another physical activator is engaged. In another example, the delay may be extended based on the length of time of engagement. The timer circuit 300 may include one or more discharge acceleration components, such as crowbar circuits, bleeder circuits, or bleeder resistors, to bleed the power from rails of the server tray circuitry. The discharge acceleration components may rapidly pull power out of a powered rail of a server tray to reduce the time required for discharge versus discharging naturally.

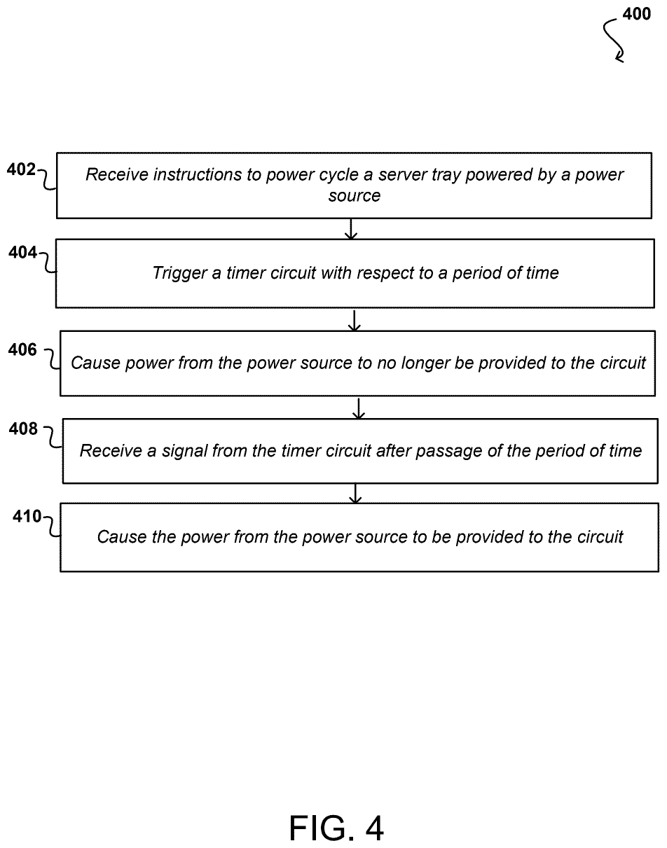

FIG. 4 illustrates an example process 400 that can be performed to power cycle a server tray of a DC busbar powered server, in accordance with at least one embodiment. It should be understood that for this and other processes presented herein that there may be additional, fewer, or alternative steps performed or similar or alternative orders, or at least partially in parallel, within the scope of the various embodiments unless otherwise specifically stated. Further, although this and other examples herein will be discussed with respect to DC busbar powered servers, there can be other types of power management for other power sources, busbars, or servers as well, within the scope of various embodiments. In this example, instructions to begin a power cycle can be received 402 for a server tray powered by a power source. The server tray may include more than one circuit and may be part of a server rack. The instructions can include one or more commands regarding the power cycle. The power source may comprise more than one power source, and may include a power busbar which receives power continuously during operation. The power cycling instruction may be received from an system external to the server tray or server rack, may be generated by a component of the server tray or the circuitry, or may be a mechanical signal generated in response to manual activation of a physical activator connected to the server tray. A timer circuit can be triggered 404 in response to the instructions with respect to a period of time. The period of time may be sufficient to allow for discharge of an amount of capacitance of the circuitry, such as the capacitors and power supplies. The timer circuit may receive instructions to adjust the period of time. The timer circuit may be able to remain powered while the remaining server tray circuitry is no longer powered.

The power from the power source can be caused 406 to no longer be provided to the server tray or the circuitry. The power may be no longer available to any of the circuitry in the server tray other than the timer circuit. The server rack, server tray, or timer circuit may include a power management component. The power management component may be able to receive the instructions to begin a power cycle, trigger the timer circuit, or cause the power from the power source to no longer be available to the circuitry. After the power is no longer provided to the server tray or the circuitry, operations of the logical components may cease, such as when capacitance of the circuitry has been dissipated. A signal from the timer circuit can be received 408 after passage of the period of time to cause power to be re-established for components of the server tray. The timer may generate a single signal to provide power to all of the server tray, or may generate multiple signals to allow for the power to be made available to different portions of the circuitry at different points in times. The power cycling may be completed by staggering the re-enabling of the power sources at different times, such as in sequence. The signal may be sent to a power supply, power management controller, or other component. The power from the power source can be caused 410 to be provided to the server tray or the circuitry. The power may be caused to be provided in response to receiving a signal from the timer circuit. After the power is provided to the server tray or the circuitry, operations of the logical components may resume. A logic device may be used to determine whether power has been successfully re-established for components of a tray, and if not can trigger another power cycle.

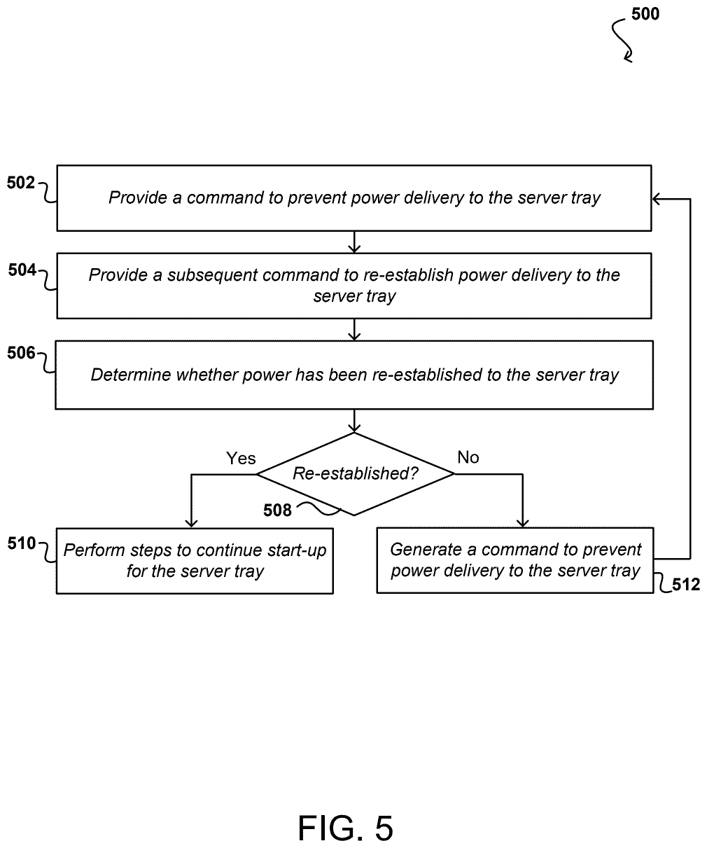

FIG. 5 illustrates an example process 500 that can be performed to determine whether power has been re-established to a server tray, in accordance with at least one embodiment. In this example, a command can be provided 502 to prevent power delivery to the server tray. The command can have been received to perform a power cycle of the server tray as discussed herein, using a process such as that discussed with respect to FIG. 4. The command may be generated remotely or locally, such as by a physical activator or a component of the server tray circuitry. A trigger-based circuit may receive the command, allowing for the power to not be available to the server tray for a period of time. A command can be provided 504 to re-establish power delivery to the server tray. The trigger-based circuit may generate the command to re-establish power delivery after the period of time. The command may be provided as more than one command, such as to provide power to components of the server tray at different times. The power can be determined 506 to have been re-established to the server tray. A logic device may perform a check of whether one or more components of the server tray are powered. The logic device may repeat the check, such as after a set amount of time until the power cycle of the server tray complete. If it is determined 508 that power has been re-established to the server tray, then steps can be performed 510 to continue start-up for the server tray. If it is instead determined 508 that power not has been re-established to the server tray, then a command can be generated 512 to prevent power delivery to the server tray. One or more components of the server tray may not have had power re-established, or power may not have been re-established to components of the server tray according to a specified order or sequence. The generated command can be provided, such as to the timer-based circuit, to repeat the power cycle.

In at least some of these examples, client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, which sits on a network edge and is outside at least one security layer associated with the cloud provider environment. In this way, latency can be reduced by allowing the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device or may incorporate one or more Virtual Machines (VMs). In at least one embodiment, such a system can be implemented at least partially in a data center or at least partially using cloud computing resources.

### Data Center

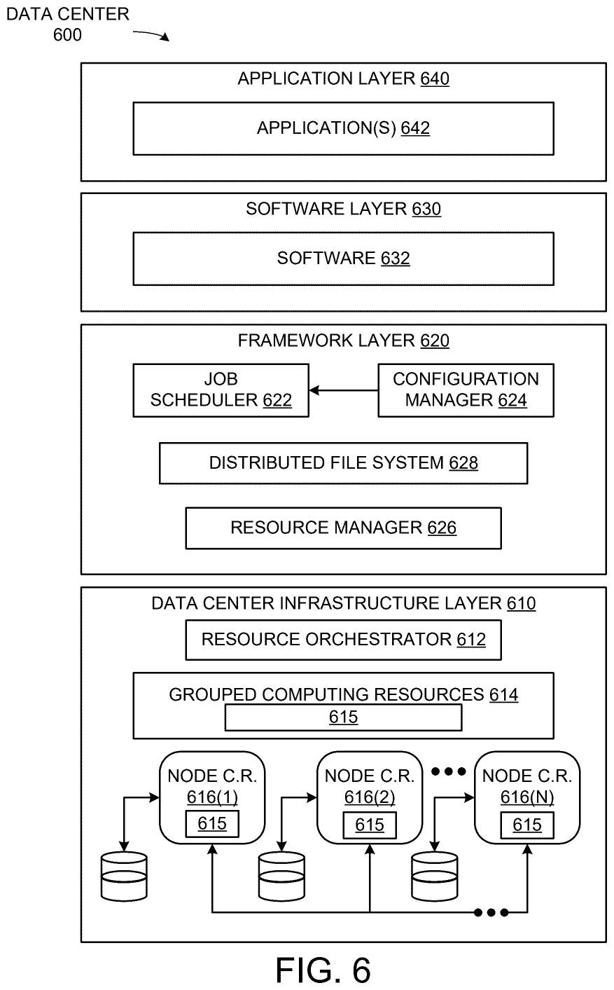

FIG. 6 illustrates an example data center 600, in which at least one embodiment may be used. In at least one embodiment, data center 600 includes a data center infrastructure layer 610, a framework layer 620, a software layer 630 and an application layer 640.

In at least one embodiment, as shown in FIG. 6, data center infrastructure layer 610 may include a resource orchestrator 612, grouped computing resources 614, and node computing resources (“node C.R.s”) 616(1)-616(N), where “N” represents a positive integer (which may be a different integer “N” than used in other figures). In at least one embodiment, node C.R.s 616(1)-616(N) may include, but are not limited to, any number of central processing units (“CPUs”) or other processors (including accelerators, field programmable gate arrays (FPGAs), graphics processors, etc.), memory storage devices 618(1)-618(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 616(1)-616(N) may be a server having one or more of above-mentioned computing resources.

In at least one embodiment, grouped computing resources 614 may include separate groupings of node C.R.s housed within one or more racks (not shown), or many racks housed in data centers at various geographical locations (also not shown). In at least one embodiment, separate groupings of node C.R.s within grouped computing resources 614 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 612 may configure or otherwise control one or more node C.R.s 616(1)-616(N) and/or grouped computing resources 614. In at least one embodiment, resource orchestrator 612 may include a software design infrastructure (“SDI”) management entity for data center 600. In at least one embodiment, resource orchestrator 612 may include hardware, software or some combination thereof.

In at least one embodiment, as shown in FIG. 6, framework layer 620 includes a job scheduler 622, a configuration manager 624, a resource manager 626 and a distributed file system 628. In at least one embodiment, framework layer 620 may include a framework to support software 632 of software layer 630 and/or one or more application(s) 642 of application layer 640. In at least one embodiment, software 632 or application(s) 642 may respectively include web-based service software or applications, such as those provided by Amazon Web Services, Google Cloud and Microsoft Azure. In at least one embodiment, framework layer 620 may be, but is not limited to, a type of free and open-source software web application framework such as Apache Spark™ (hereinafter “Spark”) that may use distributed file system 628 for large-scale data processing (e.g., “big data”). In at least one embodiment, job scheduler 622 may include a Spark driver to facilitate scheduling of workloads supported by various layers of data center 600. In at least one embodiment, configuration manager 624 may be capable of configuring different layers such as software layer 630 and framework layer 620 including Spark and distributed file system 628 for supporting large-scale data processing. In at least one embodiment, resource manager 626 may be capable of managing clustered or grouped computing resources mapped to or allocated for support of distributed file system 628 and job scheduler 622. In at least one embodiment, clustered or grouped computing resources may include grouped computing resources 614 at data center infrastructure layer 610. In at least one embodiment, resource manager 626 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 628 of framework layer 620. In at least one embodiment, one or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 628 of framework layer 620. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 624, resource manager 626, and resource orchestrator 612 may implement any number and type of self-modifying actions based on any amount and type of data acquired in any technically feasible fashion. In at least one embodiment, self-modifying actions may relieve a data center operator of data center 600 from making possibly bad configuration decisions and possibly avoiding underused and/or poor performing portions of a data center.

In at least one embodiment, data center 600 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 600. In at least one embodiment, trained machine learning models corresponding to one or more neural networks may be used to infer or predict information using resources described above with respect to data center 600 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 6 for inferencing or predicting operations based, at least in part, on weight parameters calculated using neural network training operations, neural network functions and/or architectures, or neural network use cases described herein.

Embodiments presented herein can manage one or more power cycle functions for a server tray or circuitry within a server tray using a timer-based circuit.

### Computer Systems

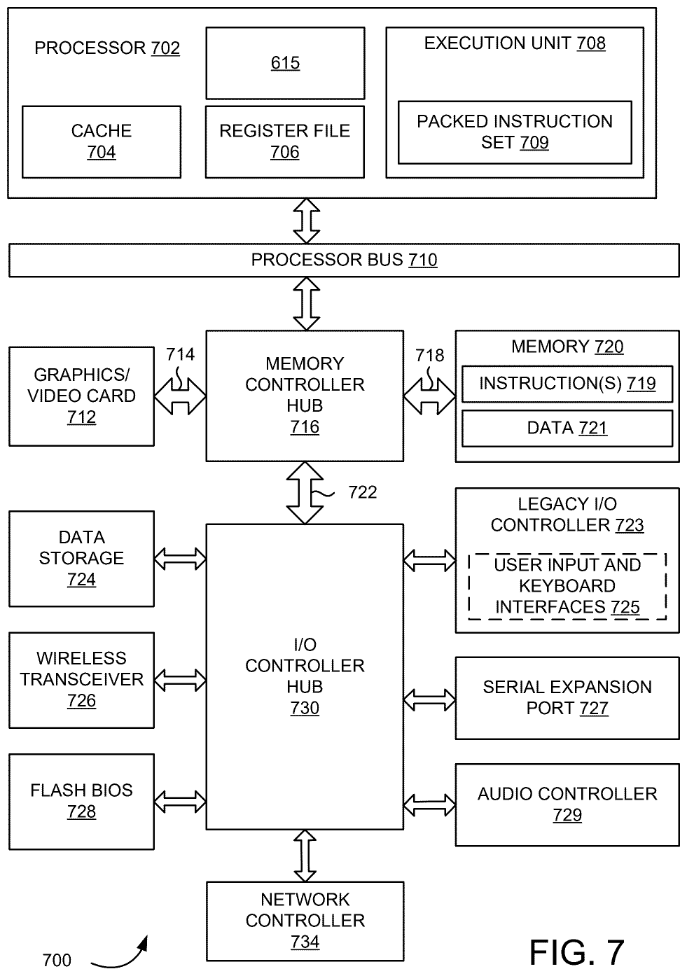

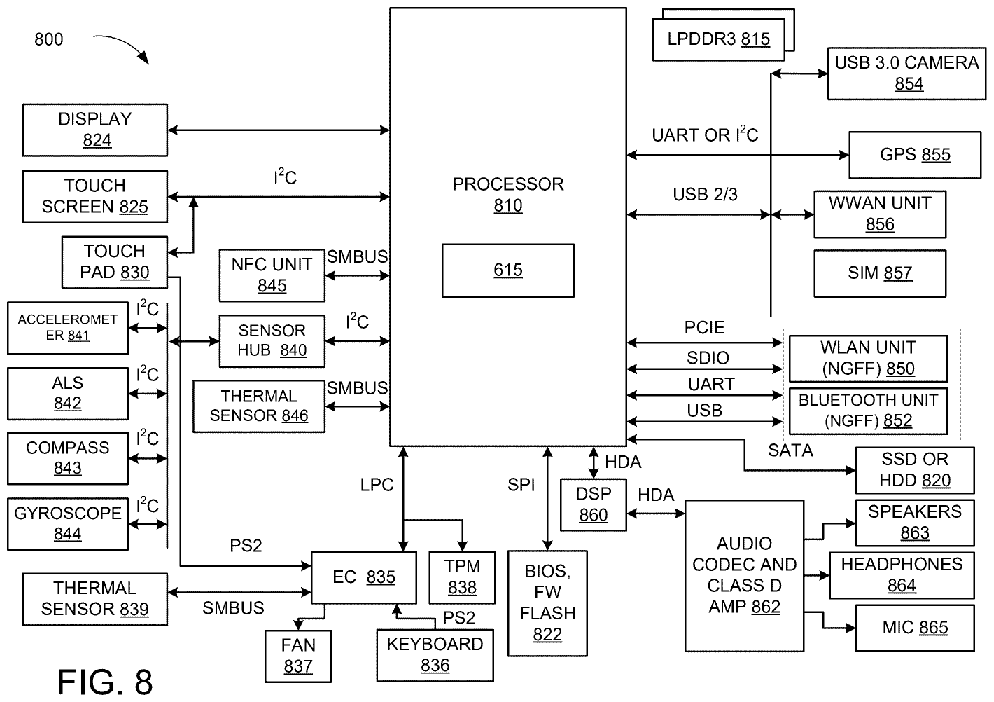

FIG. 7 is a block diagram illustrating an exemplary computer system, which may be a system with interconnected devices and components, a system-on-a-chip (SOC) or some combination thereof formed with a processor that may include execution units to execute an instruction, according to at least one embodiment. In at least one embodiment, a computer system 700 may include, without limitation, a component, such as a processor 702 to employ execution units including logic to perform algorithms for process data, in accordance with present disclosure, such as in embodiment described herein. In at least one embodiment, computer system 700 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 700 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 700 may include, without limitation, processor 702 that may include, without limitation, one or more execution units 708 to perform machine learning model training and/or inferencing according to techniques described herein. In at least one embodiment, computer system 700 is a single processor desktop or server system, but in another embodiment, computer system 700 may be a multiprocessor system. In at least one embodiment, processor 702 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 702 may be coupled to a processor bus 710 that may transmit data signals between processor 702 and other components in computer system 700.

In at least one embodiment, processor 702 may include, without limitation, a Level 1 (“L1”) internal cache memory (“cache”) 704. In at least one embodiment, processor 702 may have a single internal cache or multiple levels of internal cache. In at least one embodiment, cache memory may reside external to processor 702. Other embodiments may also include a combination of both internal and external caches depending on particular implementation and needs. In at least one embodiment, a register file 706 may store different types of data in various registers including, without limitation, integer registers, floating point registers, status registers, and an instruction pointer register.

In at least one embodiment, execution unit 708, including, without limitation, logic to perform integer and floating point operations, also resides in processor 702. In at least one embodiment, processor 702 may also include a microcode (“ucode”) read only memory (“ROM”) that stores microcode for certain macro instructions. In at least one embodiment, execution unit 708 may include logic to handle a packed instruction set 709. In at least one embodiment, by including packed instruction set 709 in an instruction set of a general-purpose processor, along with associated circuitry to execute instructions, operations used by many multimedia applications may be performed using packed data in processor 702. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 708 may also be used in microcontrollers, embedded processors, graphics devices, DSPs, and other types of logic circuits. In at least one embodiment, computer system 700 may include, without limitation, a memory 720. In at least one embodiment, memory 720 may be a Dynamic Random Access Memory (“DRAM”) device, a Static Random Access Memory (“SRAM”) device, a flash memory device, or another memory device. In at least one embodiment, memory 720 may store instruction(s) 719 and/or data 721 represented by data signals that may be executed by processor 702.

In at least one embodiment, a system logic chip may be coupled to processor bus 710 and memory 720. In at least one embodiment, a system logic chip may include, without limitation, a memory controller hub (“MCH”) 716, and processor 702 may communicate with MCH 716 via processor bus 710. In at least one embodiment, MCH 716 may provide a high bandwidth memory path 718 to memory 720 for instruction and data storage and for storage of graphics commands, data, and textures. In at least one embodiment, MCH 716 may direct data signals between processor 702, memory 720, and other components in computer system 700 and to bridge data signals between processor bus 710, memory 720, and a system I/O interface 722. In at least one embodiment, a system logic chip may provide a graphics port for coupling to a graphics controller. In at least one embodiment, MCH 716 may be coupled to memory 720 through high bandwidth memory path 718 and a graphics/video card 712 may be coupled to MCH 716 through an Accelerated Graphics Port (“AGP”) interconnect 714.

In at least one embodiment, computer system 700 may use system I/O interface 722 as a proprietary hub interface bus to couple MCH 716 to an I/O controller hub (“ICH”) 730. In at least one embodiment, ICH 730 may provide direct connections to some I/O devices via a local I/O bus. In at least one embodiment, a local I/O bus may include, without limitation, a high-speed I/O bus for connecting peripherals to memory 720, a chipset, and processor 702. Examples may include, without limitation, an audio controller 729, a firmware hub (“flash BIOS”) 728, a wireless transceiver 726, a data storage 724, a legacy I/O controller 723 containing user input and keyboard interfaces 725, a serial expansion port 727, such as a Universal Serial Bus (“USB”) port, and a network controller 734. In at least one embodiment, data storage 724 may comprise a hard disk drive, a floppy disk drive, a CD-ROM device, a flash memory device, or other mass storage device.

In at least one embodiment, FIG. 7 illustrates a system, which includes interconnected hardware devices or “chips”, whereas in other embodiments, FIG. 7 may illustrate an exemplary SoC. In at least one embodiment, devices illustrated in FIG. 7 may be interconnected with proprietary interconnects, standardized interconnects (e.g., PCIe) or some combination thereof. In at least one embodiment, one or more components of computer system 700 are interconnected using compute express link (CXL) interconnects.

Inference and/or training logic 615 are used to perform inferencing and/or training operations associated with one or more embodiments. In at least one embodiment, inference and/or training logic 615 may be used in system FIG. 7 for inferencing or predicting operations based, at least in part, on weight parameters calculated using neural network training operations, neural network functions and/or architectures, or neural network use cases described herein.

Embodiments presented herein can manage one or more power cycle functions for a server tray or circuitry within a server tray using a timer-based circuit.

FIG. 6 is a block diagram illustrating an electronic device 600 for using a processor 610, according to at least one embodiment. In at least one embodiment, electronic device 600 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 600 may include, without limitation, processor 610 communicatively coupled to any suitable number or kind of components, peripherals, modules, or devices. In at least one embodiment, processor 610 is coupled using a bus or interface, such as a I²C bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3, etc.), or a Universal Asynchronous Receiver/Transmitter (“UART”) bus. In at least one embodiment, FIG. 6 illustrates a system, which includes interconnected hardware devices or “chips”, whereas in other embodiments, FIG. 6 may illustrate an exemplary SoC. In at least one embodiment, devices illustrated in FIG. 6 may be interconnected with proprietary interconnects, standardized interconnects (e.g., PCIe) or some combination thereof. In at least one embodiment, one or more components of FIG. 6 are interconnected using compute express link (CXL) interconnects.

In at least one embodiment, FIG. 6 may include a display 624, a touch screen 625, a touch pad 630, a Near Field Communications unit (“NFC”) 645, a sensor hub 640, a thermal sensor 646, an Express Chipset (“EC”) 635, a Trusted Platform Module (“TPM”) 638, BIOS/firmware/flash memory (“BIOS, FW Flash”) 622, a DSP 660, a drive 620 such as a Solid State Disk (“SSD”) or a Hard Disk Drive (“HDD”), a wireless local area network unit (“WLAN”) 650, a Bluetooth unit 652, a Wireless Wide Area Network unit (“WWAN”) 656, a Global Positioning System (GPS) unit 655, a camera (“USB 3.0 camera”) 654 such as a USB 3.0 camera, and/or a Low Power Double Data Rate (“LPDDR”) memory unit (“LPDDR3”) 615 implemented in, for example, an LPDDR3 standard. These components may each be implemented in any suitable manner.

In at least one embodiment, other components may be communicatively coupled to processor 610 through components described herein. In at least one embodiment, an accelerometer 641, an ambient light sensor (“ALS”) 642, a compass 643, and a gyroscope 644 may be communicatively coupled to sensor hub 640. In at least one embodiment, a thermal sensor 639, a fan 637, a keyboard 636, and touch pad 630 may be communicatively coupled to EC 635. In at least one embodiment, speakers 663, headphones 664, and a microphone (“mic”) 665 may be communicatively coupled to an audio unit (“audio codec and class D amp”) 662, which may in turn be communicatively coupled to DSP 660. In at least one embodiment, audio unit 662 may include, for example and without limitation, an audio coder/decoder (“codec”) and a class D amplifier. In at least one embodiment, a SIM card (“SIM”) 657 may be communicatively coupled to WWAN unit 656. In at least one embodiment, components such as WLAN unit 650 and Bluetooth unit 652, as well as WWAN unit 656 may be implemented in a Next Generation Form Factor (“NGFF”).

Inference and/or training logic 615 are used to perform inferencing and/or training operations associated with one or more embodiments. In at least one embodiment, inference and/or training logic 615 may be used in system FIG. 6 for inferencing or predicting operations based, at least in part, on weight parameters calculated using neural network training operations, neural network functions and/or architectures, or neural network use cases described herein.

Embodiments presented herein can manage one or more power cycle functions for a server tray or circuitry within a server tray using a timer-based circuit.

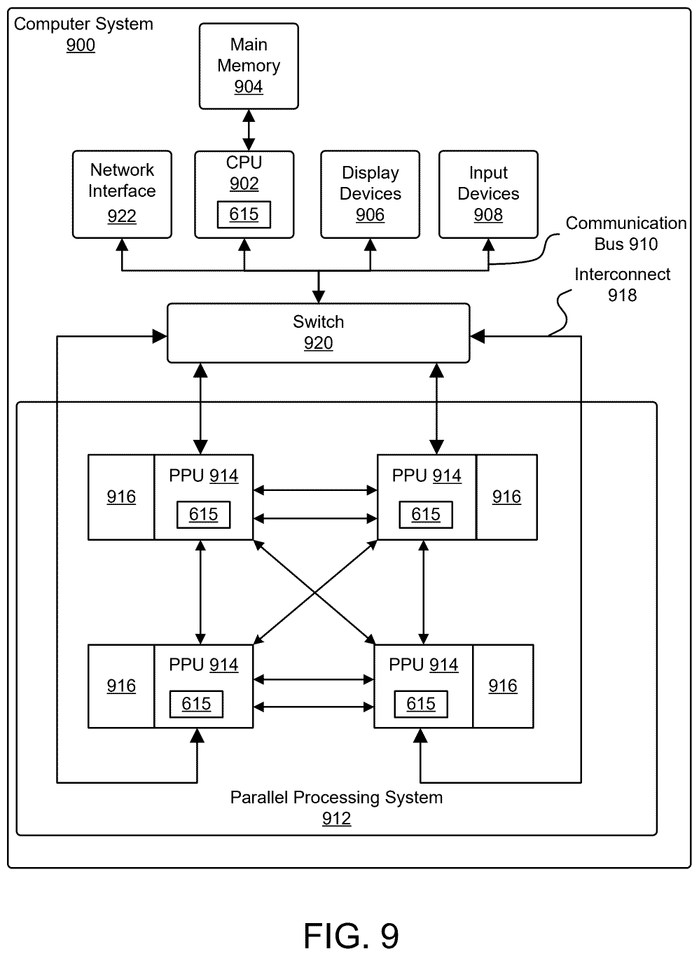

FIG. 9 illustrates a computer system 900, according to at least one embodiment. In at least one embodiment, computer system 900 is configured to implement various processes and methods described throughout this disclosure.

In at least one embodiment, computer system 900 comprises, without limitation, at least one central processing unit (“CPU”) 902 that is connected to a communication bus 910 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 900 includes, without limitation, a main memory 904 and control logic (e.g., implemented as hardware, software, or a combination thereof) and data are stored in main memory 904, which may take form of random access memory (“RAM”). In at least one embodiment, a network interface subsystem (“network interface”) 922 provides an interface to other computing devices and networks for receiving data from and transmitting data to other systems with computer system 900.

In at least one embodiment, computer system 900, in at least one embodiment, includes, without limitation, input devices 908, a parallel processing system 912, and display devices 906 that can be implemented using a conventional cathode ray tube (“CRT”), a liquid crystal display (“LCD”), a light emitting diode (“LED”) display, a plasma display, or other suitable display technologies. In at least one embodiment, user input is received from input devices 908 such as keyboard, mouse, touchpad, microphone, etc. In at least one embodiment, each module described herein can be situated on a single semiconductor platform to form a processing system.

Inference and/or training logic 615 are used to perform inferencing and/or training operations associated with one or more embodiments. In at least one embodiment, inference and/or training logic 615 may be used in system FIG. 9 for inferencing or predicting operations based, at least in part, on weight parameters calculated using neural network training operations, neural network functions and/or architectures, or neural network use cases described herein.

Embodiments presented herein can manage one or more power cycle functions for a server tray or circuitry within a server tray using a timer-based circuit.

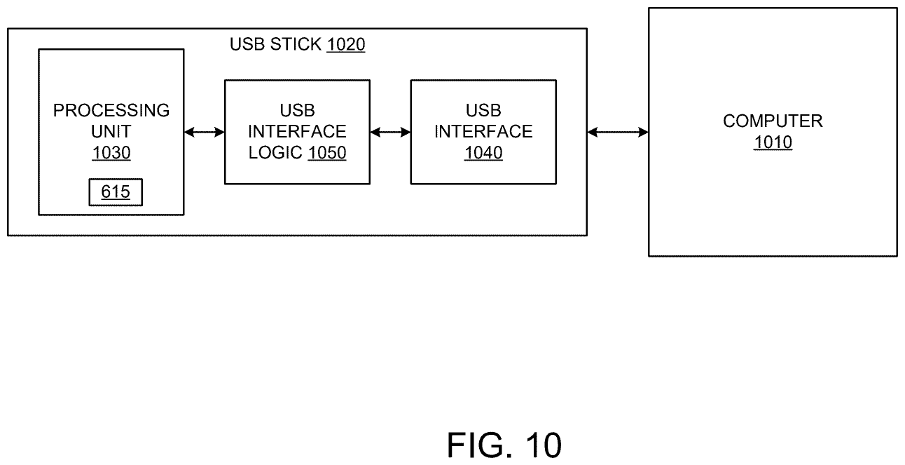

FIG. 10 illustrates a computer system 1000, according to at least one embodiment. In at least one embodiment, computer system 1000 includes, without limitation, a computer 1010 and a USB stick 1020. In at least one embodiment, computer 1010 may include, without limitation, any number and type of processor(s) (not shown) and a memory (not shown). In at least one embodiment, computer 1010 includes, without limitation, a server, a cloud instance, a laptop, and a desktop computer.

In at least one embodiment, USB stick 1020 includes, without limitation, a processing unit 1030, a USB interface 1040, and USB interface logic 1050. In at least one embodiment, processing unit 1030 may be any instruction execution system, apparatus, or device capable of executing instructions. In at least one embodiment, processing unit 1030 may include, without limitation, any number and type of processing cores (not shown). In at least one embodiment, processing unit 1030 comprises an application specific integrated circuit (“ASIC”) that is optimized to perform any amount and type of operations associated with machine learning. For instance, in at least one embodiment, processing unit 1030 is a tensor processing unit (“TPC”) that is optimized to perform machine learning inference operations. In at least one embodiment, processing unit 1030 is a vision processing unit (“VPU”) that is optimized to perform machine vision and machine learning inference operations.

In at least one embodiment, USB interface 1040 may be any type of USB connector or USB socket. For instance, in at least one embodiment, USB interface 1040 is a USB 3.0 Type-C socket for data and power. In at least one embodiment, USB interface 1040 is a USB 3.0 Type-A connector. In at least one embodiment, USB interface logic 1050 may include any amount and type of logic that enables processing unit 1030 to interface with devices (e.g., computer 1010) via USB connector 1040.

Inference and/or training logic 615 are used to perform inferencing and/or training operations associated with one or more embodiments. In at least one embodiment, inference and/or training logic 615 may be used in system FIG. 10 for inferencing or predicting operations based, at least in part, on weight parameters calculated using neural network training operations, neural network functions and/or architectures, or neural network use cases described herein.

Embodiments presented herein can manage one or more power cycle functions for a server tray or circuitry within a server tray using a timer-based circuit.

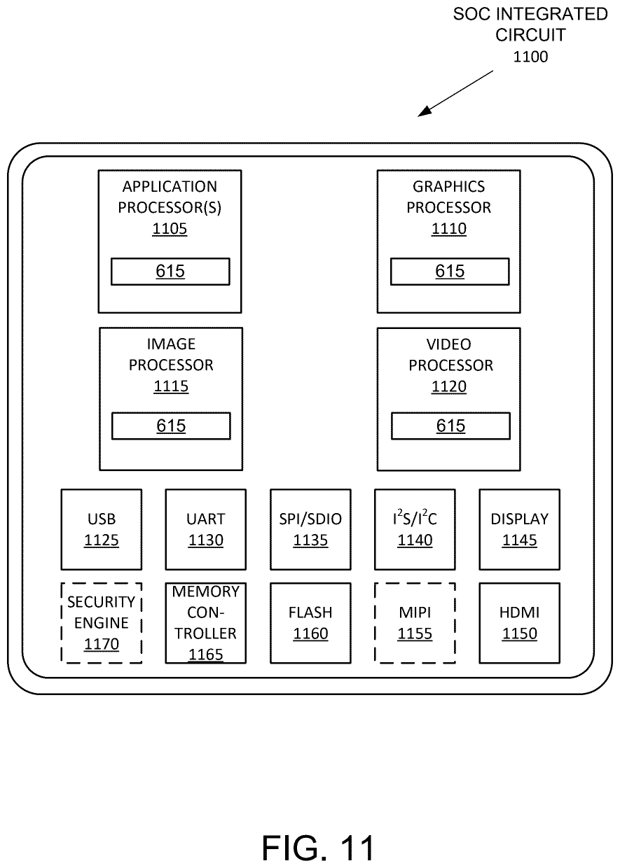

FIG. 11 illustrates exemplary integrated circuits and associated graphics processors that may be fabricated using one or more IP cores, according to various embodiments described herein. In addition to what is illustrated, other logic and circuits may be included in at least one embodiment, including additional graphics processors/cores, peripheral interface controllers, or general-purpose processor cores.

FIG. 11 is a block diagram illustrating an exemplary system-on-a-chip (SOC) integrated circuit 1100 that may be fabricated using one or more IP cores, according to at least one embodiment. In at least one embodiment, SOC integrated circuit 1100 includes one or more application processor(s) 1105 (e.g., CPUs), at least one graphics processor 1110, and may additionally include an image processor 1115 and/or a video processor 1120, any of which may be a modular IP core. In at least one embodiment, SOC integrated circuit 1100 includes peripheral or bus logic including a USB controller 1125, a UART controller 1130, an SPI/SDIO controller 1135, and an I²2S/I²2C controller 1140. In at least one embodiment, SOC integrated circuit 1100 can include a display device 1145 coupled to one or more of a high-definition multimedia interface (HDMI) controller 1150 and a mobile industry processor interface (MIPI) display interface 1155. In at least one embodiment, storage may be provided by a flash memory subsystem 1160 including flash memory and a flash memory controller. In at least one embodiment, a memory interface may be provided via a memory controller 1165 for access to SDRAM or SRAM memory devices. In at least one embodiment, some integrated circuits additionally include an embedded security engine 1170.

Inference and/or training logic 615 are used to perform inferencing and/or training operations associated with one or more embodiments. In at least one embodiment, inference and/or training logic 615 may be used in SOC integrated circuit 1100 for inferencing or predicting operations based, at least in part, on weight parameters calculated using neural network training operations, neural network functions and/or architectures, or neural network use cases described herein.

Embodiments presented herein can manage one or more power cycle functions for a server tray or circuitry within a server tray using a timer-based circuit.

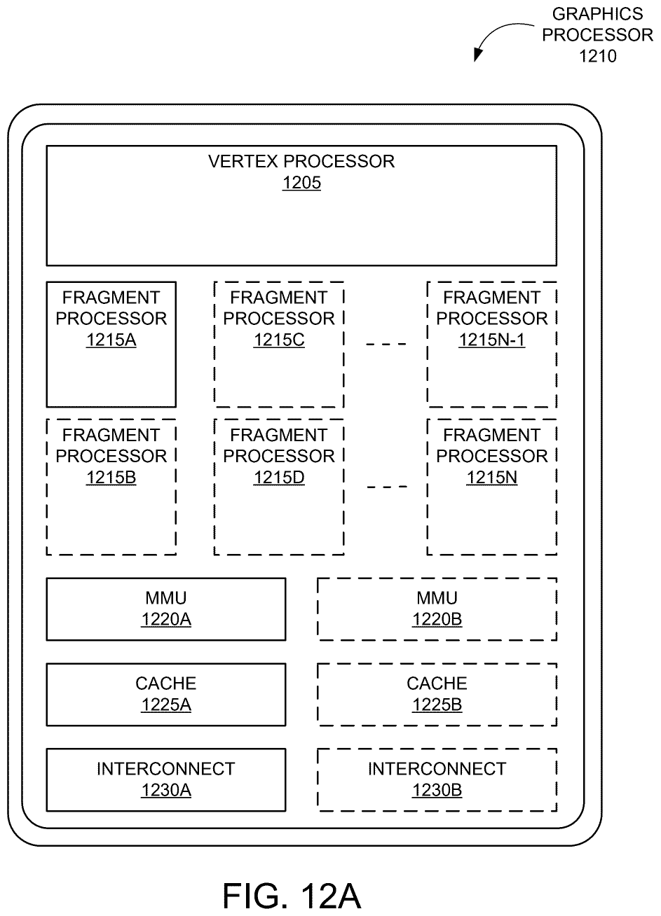

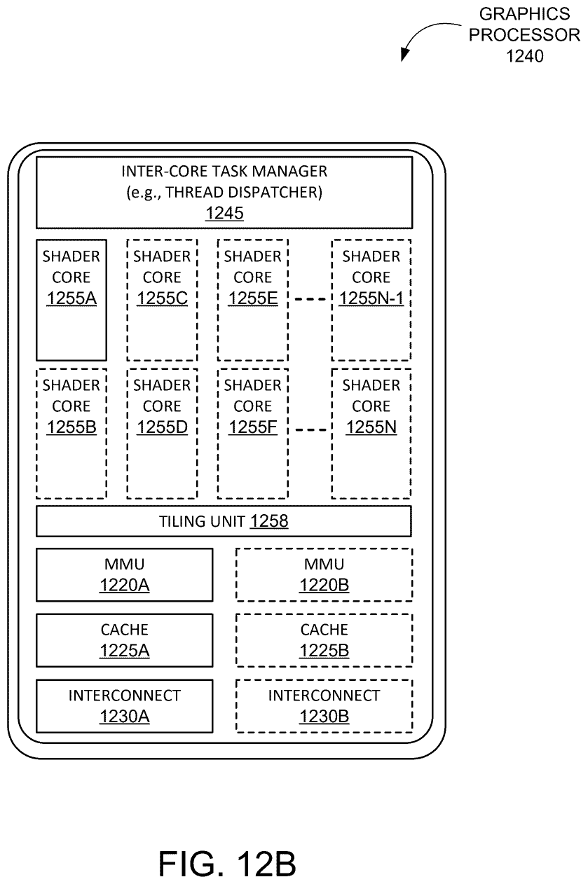

FIGS. 12A-12B illustrate exemplary integrated circuits and associated graphics processors that may be fabricated using one or more IP cores, according to various embodiments described herein. In addition to what is illustrated, other logic and circuits may be included in at least one embodiment, including additional graphics processors/cores, peripheral interface controllers, or general-purpose processor cores.

FIGS. 12A-12B are block diagrams illustrating exemplary graphics processors for use within an SoC, according to embodiments described herein. FIG. 12A illustrates an exemplary graphics processor 1210 of a system on a chip integrated circuit that may be fabricated using one or more IP cores, according to at least one embodiment. FIG. 12B illustrates an additional exemplary graphics processor 1240 of a system on a chip integrated circuit that may be fabricated using one or more IP cores, according to at least one embodiment. In at least one embodiment, graphics processor 1210 of FIG. 12A is a low power graphics processor core. In at least one embodiment, graphics processor 1240 of FIG. 12B is a higher performance graphics processor core. In at least one embodiment, each of graphics processors 1210, 1240 can be variants of computer system 1200 of FIG. 12.

In at least one embodiment, graphics processor 1210 includes a vertex processor 1205 and one or more fragment processor(s) 1215A-1215N (e.g., 1215A, 1215B, 1215C, 1215D, through 1215N-1, and 1215N). In at least one embodiment, graphics processor 1210 can execute different shader programs via separate logic, such that vertex processor 1205 is optimized to execute operations for vertex shader programs, while one or more fragment processor(s) 1215A-1215N execute fragment (e.g., pixel) shading operations for fragment or pixel shader programs. In at least one embodiment, vertex processor 1205 performs a vertex processing stage of a 3D graphics pipeline and generates primitives and vertex data. In at least one embodiment, fragment processor(s) 1215A-1215N use primitive and vertex data generated by vertex processor 1205 to produce a framebuffer that is displayed on a display device. In at least one embodiment, fragment processor(s) 1215A-1215N are optimized to execute fragment shader programs as provided for in an OpenGL API, which may be used to perform similar operations as a pixel shader program as provided for in a Direct 3D API.

In at least one embodiment, graphics processor 1210 additionally includes one or more memory management units (MMUs) 1220A-1220B, cache(s) 1225A-1225B, and circuit interconnect(s) 1230A-1230B. In at least one embodiment, one or more MMU(s) 1220A-1220B provide for virtual to physical address mapping for graphics processor 1210, including for vertex processor 1205 and/or fragment processor(s) 1215A-1215N, which may reference vertex or image/texture data stored in memory, in addition to vertex or image/texture data stored in one or more cache(s) 1225A-1225B. In at least one embodiment, one or more MMU(s) 1220A-1220B may be synchronized with other MMUs within a system, including one or more MMUs associated with one or more application processor(s) 1205, image processors 1215, and/or video processors 1220 of FIG. 12A, such that each processor 1205-1220 can participate in a shared or unified virtual memory system. In at least one embodiment, one or more circuit interconnect(s) 1230A-1230B enable graphics processor 1210 to interface with other IP cores within SoC, either via an internal bus of SoC or via a direct connection.

In at least one embodiment, graphics processor 1240 includes one or more shader core(s) 1255A-1255N (e.g., 1255A, 1255B, 1255C, 1255D, 1255E, 1255F, through 1255N-1, and 1255N) as shown in FIG. 12B, which provides for a unified shader core architecture in which a single core or type or core can execute all types of programmable shader code, including shader program code to implement vertex shaders, fragment shaders, and/or compute shaders. In at least one embodiment, a number of shader cores can vary. In at least one embodiment, graphics processor 1240 includes an inter-core task manager 1245, which acts as a thread dispatcher to dispatch execution threads to one or more shader cores 1255A-1255N and a tiling unit 1258 to accelerate tiling operations for tile-based rendering, in which rendering operations for a scene are subdivided in image space, for example to exploit local spatial coherence within a scene or to optimize use of internal caches.

Embodiments presented herein can manage one or more power cycle functions for a server tray or circuitry within a server tray using a timer-based circuit.

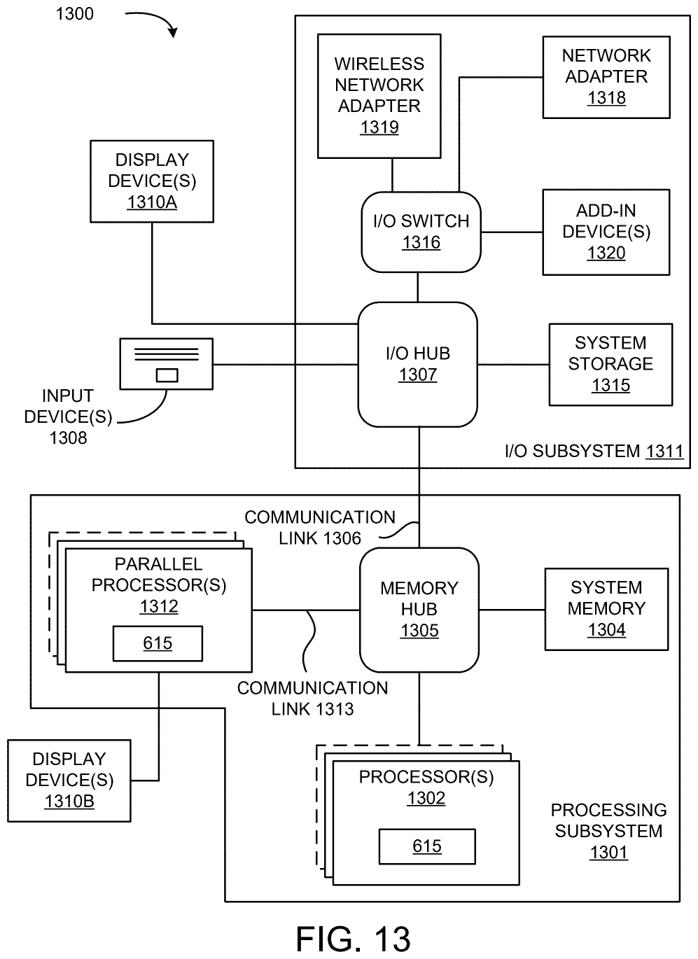

FIG. 13 is a block diagram illustrating a computing system 1300 according to at least one embodiment. In at least one embodiment, computing system 1300 includes a processing subsystem 1301 having one or more processor(s) 1302 and a system memory 1304 communicating via an interconnection path that may include a memory hub 1305. In at least one embodiment, memory hub 1305 may be a separate component within a chipset component or may be integrated within one or more processor(s) 1302. In at least one embodiment, memory hub 1305 couples with an I/O subsystem 1311 via a communication link 1306. In at least one embodiment, I/O subsystem 1311 includes an I/O hub 1307 that can enable computing system 1300 to receive input from one or more input device(s) 1308. In at least one embodiment, I/O hub 1307 can enable a display controller, which may be included in one or more processor(s) 1302, to provide outputs to one or more display device(s) 1310A. In at least one embodiment, one or more display device(s) 1310A coupled with I/O hub 1307 can include a local, internal, or embedded display device.

In at least one embodiment, processing subsystem 1301 includes one or more parallel processor(s) 1312 coupled to memory hub 1305 via a bus or other communication link 1315. In at least one embodiment, communication link 1315 may use one of any number of standards based communication link technologies or protocols, such as but not limited to PCI Express, or may be a vendor-specific communications interface or communications fabric. In at least one embodiment, one or more parallel processor(s) 1312 form a computationally focused parallel or vector processing system that can include a large number of processing cores and/or processing clusters, such as a many-integrated core (MIC) processor. In at least one embodiment, some or all of parallel processor(s) 1312 form a graphics processing subsystem that can output pixels to one of one or more display device(s) 1310A coupled via I/O hub 1307. In at least one embodiment, parallel processor(s) 1312 can also include a display controller and display interface (not shown) to enable a direct connection to one or more display device(s) 1310B. In at least one embodiment, parallel processor(s) 1312 include one or more cores, such as graphics cores 1300 discussed herein.

In at least one embodiment, a system storage unit 1314 can connect to I/O hub 1307 to provide a storage mechanism for computing system 1300. In at least one embodiment, an I/O switch 1316 can be used to provide an interface mechanism to enable connections between I/O hub 1307 and other components, such as a network adapter 1318 and/or a wireless network adapter 1319 that may be integrated into platform, and various other devices that can be added via one or more add-in device(s) 1320. In at least one embodiment, network adapter 1318 can be an Ethernet adapter or another wired network adapter. In at least one embodiment, wireless network adapter 1319 can include one or more of a Wi-Fi, Bluetooth, near field communication (NFC), or other network device that includes one or more wireless radios.

In at least one embodiment, computing system 1300 can include other components not explicitly shown, including USB or other port connections, optical storage drives, video capture devices, and like, may also be connected to I/O hub 1307. In at least one embodiment, communication paths interconnecting various components in FIG. 13 may be implemented using any suitable protocols, such as PCI (Peripheral Component Interconnect) based protocols (e.g., PCI-Express), or other bus or point-to-point communication interfaces and/or protocol(s), such as NV-Link high-speed interconnect, or interconnect protocols.

In at least one embodiment, parallel processor(s) 1312 incorporate circuitry optimized for graphics and video processing, including, for example, video output circuitry, and constitutes a graphics processing unit (GPU), e.g., parallel processor(s) 1312 includes graphics core 1300.

In at least one embodiment, parallel processor(s) 1312 incorporate circuitry optimized for general purpose processing. In at least embodiment, components of computing system 1300 may be integrated with one or more other system elements on a single integrated circuit. For example, in at least one embodiment, parallel processor(s) 1312, memory hub 1305, processor(s) 1302, and I/O hub 1307 can be integrated into a system on chip (SoC) integrated circuit. In at least one embodiment, components of computing system 1300 can be integrated into a single package to form a system in package (SIP) configuration. In at least one embodiment, at least a portion of components of computing system 1300 can be integrated into a multi-chip module (MCM), which can be interconnected with other multi-chip modules into a modular computing system.

Inference and/or training logic 613 are used to perform inferencing and/or training operations associated with one or more embodiments. In at least one embodiment, inference and/or training logic 613 may be used in system FIG. 13 for inferencing or predicting operations based, at least in part, on weight parameters calculated using neural network training operations, neural network functions and/or architectures, or neural network use cases described herein.

Embodiments presented herein can manage one or more power cycle functions for a server tray or circuitry within a server tray using a timer-based circuit.

### Processors

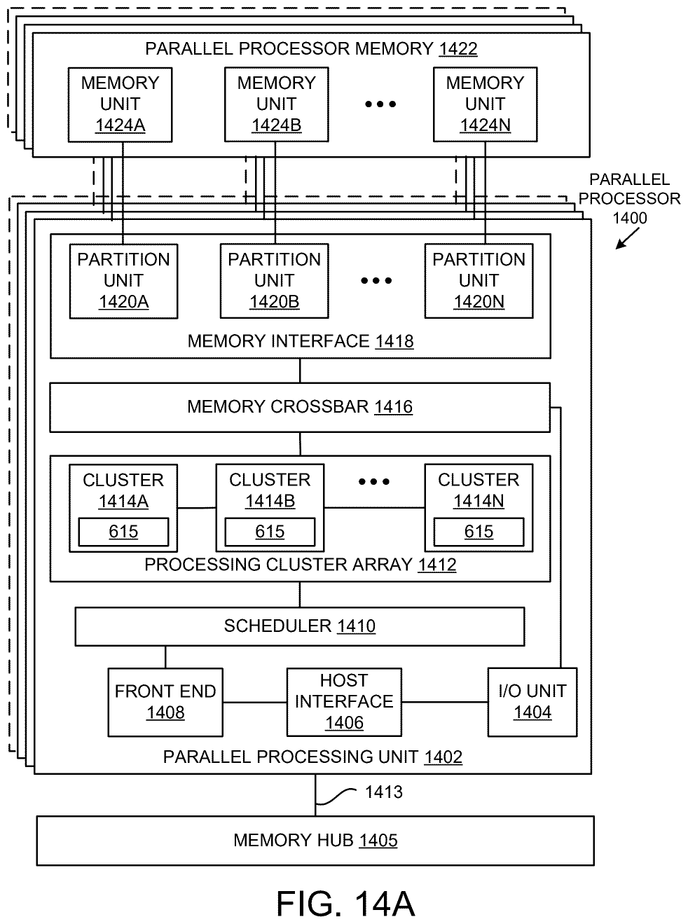

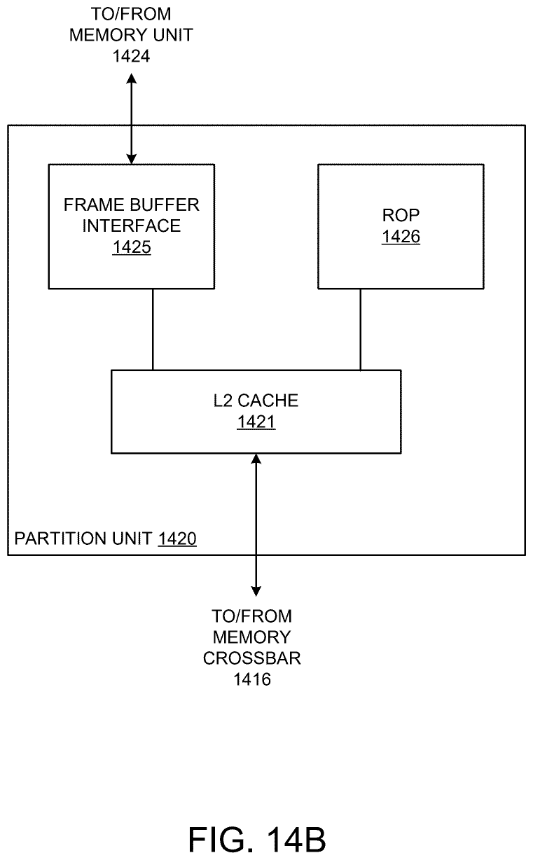

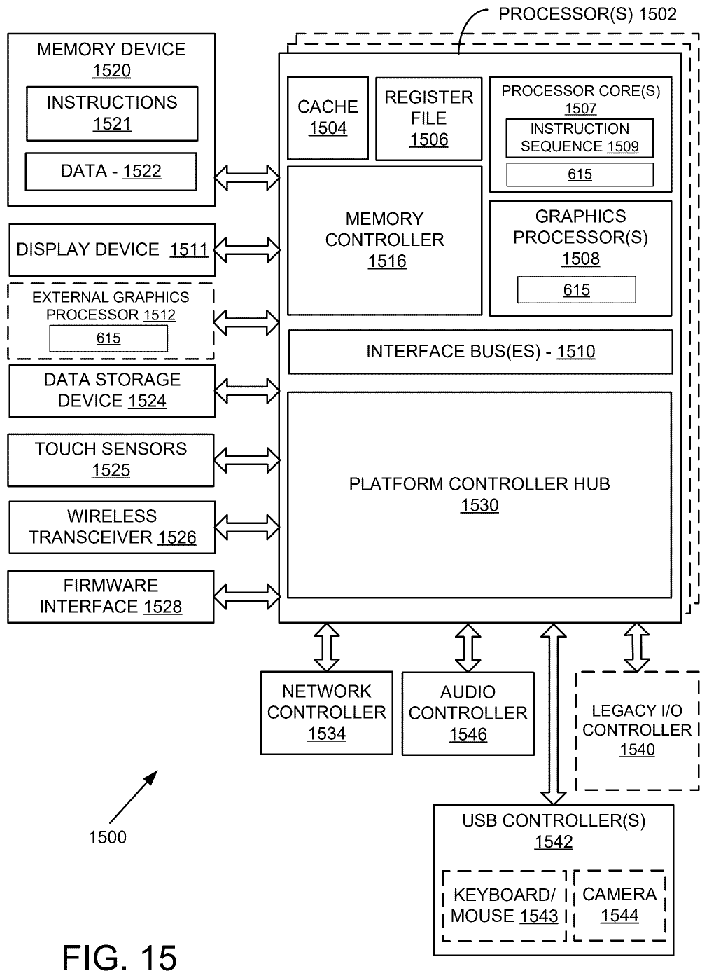

FIG. 14A illustrates a parallel processor 1400 according to at least one embodiment. In at least one embodiment, various components of parallel processor 1400 may be implemented using one or more integrated circuit devices, such as programmable processors, application specific integrated circuits (ASICs), or field programmable gate arrays (FPGA). In at least one embodiment, illustrated parallel processor 1400 is a variant of one or more parallel processor(s) 1512 shown in FIG. 15 according to an exemplary embodiment. In at least one embodiment, a parallel processor 1400 includes one or more graphics cores 1500.

In at least one embodiment, parallel processor 1400 includes a parallel processing unit 1402. In at least one embodiment, parallel processing unit 1402 includes an I/O unit 1404 that enables communication with other devices, including other instances of parallel processing unit 1402. In at least one embodiment, I/O unit 1404 may be directly connected to other devices. In at least one embodiment, I/O unit 1404 connects with other devices via use of a hub or switch interface, such as a memory hub 1405. In at least one embodiment, connections between memory hub 1405 and I/O unit 1404 form a communication link 1413. In at least one embodiment, I/O unit 1404 connects with a host interface 1406 and a memory crossbar 1416, where host interface 1406 receives commands directed to performing processing operations and memory crossbar 1416 receives commands directed to performing memory operations.

In at least one embodiment, when host interface 1406 receives a command buffer via I/O unit 1404, host interface 1406 can direct work operations to perform those commands to a front end 1408. In at least one embodiment, front end 1408 couples with a scheduler 1410 (which may be referred to as a sequencer), which is configured to distribute commands or other work items to a processing cluster array 1412. In at least one embodiment, scheduler 1410 ensures that processing cluster array 1412 is properly configured and in a valid state before tasks are distributed to a cluster of processing cluster array 1412. In at least one embodiment, scheduler 1410 is implemented via firmware logic executing on a microcontroller. In at least one embodiment, microcontroller implemented scheduler 1410 is configurable to perform complex scheduling and work distribution operations at coarse and fine granularity, enabling rapid preemption and context switching of threads executing on processing array 1412. In at least one embodiment, host software can prove workloads for scheduling on processing cluster array 1412 via one of multiple graphics processing paths. In at least one embodiment, workloads can then be automatically distributed across processing array cluster 1412 by scheduler 1410 logic within a microcontroller including scheduler 1410.

In at least one embodiment, processing cluster array 1412 can include up to “N” processing clusters (e.g., cluster 1414A, cluster 1414B, through cluster 1414N), where “N” represents a positive integer (which may be a different integer “N” than used in other figures). In at least one embodiment, each cluster 1414A-1414N of processing cluster array 1412 can execute a large number of concurrent threads. In at least one embodiment, scheduler 1410 can allocate work to clusters 1414A-1414N of processing cluster array 1412 using various scheduling and/or work distribution algorithms, which may vary depending on workload arising for each type of program or computation. In at least one embodiment, scheduling can be handled dynamically by scheduler 1410, or can be assisted in part by compiler logic during compilation of program logic configured for execution by processing cluster array 1412. In at least one embodiment, different clusters 1414A-1414N of processing cluster array 1412 can be allocated for processing different types of programs or for performing different types of computations.

In at least one embodiment, processing cluster array 1412 can be configured to perform various types of parallel processing operations. In at least one embodiment, processing cluster array 1412 is configured to perform general-purpose parallel compute operations. For example, in at least one embodiment, processing cluster array 1412 can include logic to execute processing tasks including filtering of video and/or audio data, performing modeling operations, including physics operations, and performing data transformations.

In at least one embodiment, processing cluster array 1412 is configured to perform parallel graphics processing operations. In at least one embodiment, processing cluster array 1412 can include additional logic to support execution of such graphics processing operations, including but not limited to, texture sampling logic to perform texture operations, as well as tessellation logic and other vertex processing logic. In at least one embodiment, processing cluster array 1412 can be configured to execute graphics processing related shader programs such as but not limited to, vertex shaders, tessellation shaders, geometry shaders, and pixel shaders. In at least one embodiment, parallel processing unit 1402 can transfer data from system memory via I/O unit 1404 for processing. In at least one embodiment, during processing, transferred data can be stored to on-chip memory (e.g., parallel processor memory 1422) during processing, then written back to system memory.

In at least one embodiment, when parallel processing unit 1402 is used to perform graphics processing, scheduler 1410 can be configured to divide a processing workload into approximately equal sized tasks, to better enable distribution of graphics processing operations to multiple clusters 1414A-1414N of processing cluster array 1412. In at least one embodiment, portions of processing cluster array 1412 can be configured to perform different types of processing. For example, in at least one embodiment, a first portion may be configured to perform vertex shading and topology generation, a second portion may be configured to perform tessellation and geometry shading, and a third portion may be configured to perform pixel shading or other screen space operations, to produce a rendered image for display. In at least one embodiment, intermediate data produced by one or more of clusters 1414A-1414N may be stored in buffers to allow intermediate data to be transmitted between clusters 1414A-1414N for further processing.

In at least one embodiment, processing cluster array 1412 can receive processing tasks to be executed via scheduler 1410, which receives commands defining processing tasks from front end 1408. In at least one embodiment, processing tasks can include indices of data to be processed, e.g., surface (patch) data, primitive data, vertex data, and/or pixel data, as well as state parameters and commands defining how data is to be processed (e.g., what program is to be executed). In at least one embodiment, scheduler 1410 may be configured to fetch indices corresponding to tasks or may receive indices from front end 1408. In at least one embodiment, front end 1408 can be configured to ensure processing cluster array 1412 is configured to a valid state before a workload specified by incoming command buffers (e.g., batch-buffers, push buffers, etc.) is initiated.

In at least one embodiment, each of one or more instances of parallel processing unit 1402 can couple with a parallel processor memory 1422. In at least one embodiment, parallel processor memory 1422 can be accessed via memory crossbar 1416, which can receive memory requests from processing cluster array 1412 as well as I/O unit 1404. In at least one embodiment, memory crossbar 1416 can access parallel processor memory 1422 via a memory interface 1418. In at least one embodiment, memory interface 1418 can include multiple partition units (e.g., partition unit 1420A, partition unit 1420B, through partition unit 1420N) that can each couple to a portion (e.g., memory unit) of parallel processor memory 1422. In at least one embodiment, a number of partition units 1420A-1420N is configured to be equal to a number of memory units, such that a first partition unit 1420A has a corresponding first memory unit 1424A, a second partition unit 1420B has a corresponding memory unit 1424B, and an N-th partition unit 1420N has a corresponding N-th memory unit 1424N. In at least one embodiment, a number of partition units 1420A-1420N may not be equal to a number of memory units.

In at least one embodiment, memory units 1424A-1424N can include various types of memory devices, including dynamic random access memory (DRAM) or graphics random access memory, such as synchronous graphics random access memory (SGRAM), including graphics double data rate (GDDR) memory. In at least one embodiment, memory units 1424A-1424N may also include 3D stacked memory, including but not limited to high bandwidth memory (HBM), HBM2e, or HDM3. In at least one embodiment, render targets, such as frame buffers or texture maps may be stored across memory units 1424A-1424N, allowing partition units 1420A-1420N to write portions of each render target in parallel to efficiently use available bandwidth of parallel processor memory 1422. In at least one embodiment, a local instance of parallel processor memory 1422 may be excluded in favor of a unified memory design that uses system memory in conjunction with local cache memory.

In at least one embodiment, any one of clusters 1414A-1414N of processing cluster array 1412 can process data that will be written to any of memory units 1424A-1424N within parallel processor memory 1422. In at least one embodiment, memory crossbar 1416 can be configured to transfer an output of each cluster 1414A-1414N to any partition unit 1420A-1420N or to another cluster 1414A-1414N, which can perform additional processing operations on an output. In at least one embodiment, each cluster 1414A-1414N can communicate with memory interface 1418 through memory crossbar 1416 to read from or write to various external memory devices. In at least one embodiment, memory crossbar 1416 has a connection to memory interface 1418 to communicate with I/O unit 1404, as well as a connection to a local instance of parallel processor memory 1422, enabling processing units within different processing clusters 1414A-1414N to communicate with system memory or other memory that is not local to parallel processing unit 1402. In at least one embodiment, memory crossbar 1416 can use virtual channels to separate traffic streams between clusters 1414A-1414N and partition units 1420A-1420N.

In at least one embodiment, multiple instances of parallel processing unit 1402 can be provided on a single add-in card, or multiple add-in cards can be interconnected. In at least one embodiment, different instances of parallel processing unit 1402 can be configured to interoperate even if different instances have different numbers of processing cores, different amounts of local parallel processor memory, and/or other configuration differences. For example, in at least one embodiment, some instances of parallel processing unit 1402 can include higher precision floating point units relative to other instances. In at least one embodiment, systems incorporating one or more instances of parallel processing unit 1402 or parallel processor 1400 can be implemented in a variety of configurations and form factors, including but not limited to desktop, laptop, or handheld personal computers, servers, workstations, game consoles, and/or embedded systems.

FIG. 14B is a block diagram of a partition unit 1420 according to at least one embodiment. In at least one embodiment, partition unit 1420 is an instance of one of partition units 1420A-1420N of FIG. 14A. In at least one embodiment, partition unit 1420 includes an L2 cache 1421, a frame buffer interface 1425, and a ROP 1426 (raster operations unit). In at least one embodiment, L2 cache 1421 is a read/write cache that is configured to perform load and store operations received from memory crossbar 1416 and ROP 1426. In at least one embodiment, read misses and urgent write-back requests are output by L2 cache 1421 to frame buffer interface 1425 for processing. In at least one embodiment, updates can also be sent to a frame buffer via frame buffer interface 1425 for processing. In at least one embodiment, frame buffer interface 1425 interfaces with one of memory units in parallel processor memory, such as memory units 1424A-1424N of FIG. 14A (e.g., within parallel processor memory 1422).

In at least one embodiment, ROP 1426 is a processing unit that performs raster operations such as stencil, z test, blending, etc. In at least one embodiment, ROP 1426 then outputs processed graphics data that is stored in graphics memory. In at least one embodiment, ROP 1426 includes compression logic to compress depth or color data that is written to memory and decompress depth or color data that is read from memory. In at least one embodiment, compression logic can be lossless compression logic that makes use of one or more of multiple compression algorithms. In at least one embodiment, a type of compression that is performed by ROP 1426 can vary based on statistical characteristics of data to be compressed. For example, in at least one embodiment, delta color compression is performed on depth and color data on a per-tile basis.

In at least one embodiment, ROP 1426 is included within each processing cluster (e.g., cluster 1414A-1414N of FIG. 14A) instead of within partition unit 1420. In at least one embodiment, read and write requests for pixel data are transmitted over memory crossbar 1416 instead of pixel fragment data. In at least one embodiment, processed graphics data may be displayed on a display device, such as one of one or more display device(s) 1510 of FIG. 15, routed for further processing by processor(s) 1402, or routed for further processing by one of processing entities within parallel processor 1400 of FIG. 14A.

FIG. 15 is a block diagram of a processing system, according to at least one embodiment. In at least one embodiment, system 1500 includes one or more processor(s) 1502 and one or more graphics processor(s) 1508, and may be a single processor desktop system, a multiprocessor workstation system, or a server system having a large number of processor(s) 1502 or processor core(s) 1507. In at least one embodiment, system 1500 is a processing platform incorporated within a system-on-a-chip (SoC) integrated circuit for use in mobile, handheld, or embedded devices. In at least one embodiment, one or more graphics processor(s) 1508 include one or more graphics cores 1500.

In at least one embodiment, system 1500 can include, or be incorporated within a server-based gaming platform, a game console, including a game and media console, a mobile gaming console, a handheld game console, or an online game console. In at least one embodiment, system 1500 is a mobile phone, a smart phone, a tablet computing device or a mobile Internet device. In at least one embodiment, processing system 1500 can also include, couple with, or be integrated within a wearable device, such as a smart watch wearable device, a smart eyewear device, an augmented reality device, or a virtual reality device. In at least one embodiment, processing system 1500 is a television or set top box device having one or more processor(s) 1502 and a graphical interface generated by one or more graphics processor(s) 1508.

In at least one embodiment, one or more processor(s) 1502 each include one or more processor core(s) 1507 to process instructions which, when executed, perform operations for system and user software. In at least one embodiment, each of one or more processor core(s) 1507 is configured to process a specific instruction sequence 1509. In at least one embodiment, instruction sequence 1509 may facilitate Complex Instruction Set Computing (CISC), Reduced Instruction Set Computing (RISC), or computing via a Very Long Instruction Word (VLIW). In at least one embodiment, processor core(s) 1507 may each process a different instruction sequence 1509, which may include instructions to facilitate emulation of other instruction sequences. In at least one embodiment, processor core(s) 1507 may also include other processing devices, such a Digital Signal Processor (DSP).

In at least one embodiment, processor(s) 1502 includes a cache memory 1504. In at least one embodiment, processor(s) 1502 can have a single internal cache or multiple levels of internal cache. In at least one embodiment, cache memory is shared among various components of processor(s) 1502. In at least one embodiment, processor(s) 1502 also uses an external cache (e.g., a Level-3 (L3) cache or Last Level Cache (LLC)) (not shown), which may be shared among processor core(s) 1507 using known cache coherency techniques. In at least one embodiment, a register file 1506 is additionally included in processor(s) 1502, which may include different types of registers for storing different types of data (e.g., integer registers, floating point registers, status registers, and an instruction pointer register). In at least one embodiment, register file 1506 may include general-purpose registers or other registers.

In at least one embodiment, one or more processor(s) 1502 are coupled with one or more interface bus(es) 1510 to transmit communication signals such as address, data, or control signals between processor(s) 1502 and other components in system 1500. In at least one embodiment, interface bus(es) 1510 can be a processor bus, such as a version of a Direct Media Interface (DMI) bus. In at least one embodiment, interface bus(es) 1510 is not limited to a DMI bus, and may include one or more Peripheral Component Interconnect buses (e.g., PCI, PCI Express), memory busses, or other types of interface busses. In at least one embodiment processor(s) 1502 include an integrated memory controller 1516 and a platform controller hub 1530. In at least one embodiment, memory controller 1516 facilitates communication between a memory device and other components of system 1500, while platform controller hub (PCH) 1530 provides connections to I/O devices via a local I/O bus.

In at least one embodiment, a memory device 1520 can be a dynamic random access memory (DRAM) device, a static random access memory (SRAM) device, flash memory device, phase-change memory device, or some other memory device having suitable performance to serve as process memory. In at least one embodiment, memory device 1520 can operate as system memory for system 1500, to store data 1522 and instructions 1521 for use when one or more processor(s) 1502 executes an application or process. In at least one embodiment, memory controller 1516 also couples with an optional external graphics processor 1512, which may communicate with one or more graphics processor(s) 1508 in processor(s) 1502 to perform graphics and media operations. In at least one embodiment, a display device 1511 can connect to processor(s) 1502. In at least one embodiment, display device 1511 can include one or more of an internal display device, as in a mobile electronic device or a laptop device, or an external display device attached via a display interface (e.g., DisplayPort, etc.). In at least one embodiment, display device 1511 can include a head mounted display (HMD) such as a stereoscopic display device for use in virtual reality (VR) applications or augmented reality (AR) applications.

In at least one embodiment, platform controller hub 1530 enables peripherals to connect to memory device 1520 and processor(s) 1502 via a high-speed I/O bus. In at least one embodiment, I/O peripherals include, but are not limited to, an audio controller 1546, a network controller 1534, a firmware interface 1528, a wireless transceiver 1526, touch sensors 1525, a data storage device 1524 (e.g., hard disk drive, flash memory, etc.). In at least one embodiment, data storage device 1524 can connect via a storage interface (e.g., SATA) or via a peripheral bus, such as a Peripheral Component Interconnect bus (e.g., PCI, PCI Express). In at least one embodiment, touch sensors 1525 can include touch screen sensors, pressure sensors, or fingerprint sensors. In at least one embodiment, wireless transceiver 1526 can be a Wi-Fi transceiver, a Bluetooth transceiver, or a mobile network transceiver such as a 3G, 4G, or Long Term Evolution (LTE) transceiver. In at least one embodiment, firmware interface 1528 enables communication with system firmware, and can be, for example, a unified extensible firmware interface (UEFI). In at least one embodiment, network controller 1534 can enable a network connection to a wired network. In at least one embodiment, a high-performance network controller (not shown) couples with interface bus(es) 1510. In at least one embodiment, audio controller 1546 is a multi-channel high definition audio controller. In at least one embodiment, system 1500 includes an optional legacy I/O controller 1540 for coupling legacy (e.g., Personal System 2 (PS/2)) devices to system 1500. In at least one embodiment, platform controller hub 1530 can also connect to one or more Universal Serial Bus (USB) controller(s) 1542 connect input devices, such as keyboard and mouse 1543 combinations, a camera 1544, or other USB input devices.

In at least one embodiment, an instance of memory controller 1516 and platform controller hub 1530 may be integrated into a discreet external graphics processor, such as external graphics processor 1512. In at least one embodiment, platform controller hub 1530 and/or memory controller 1516 may be external to one or more processor(s) 1502. For example, in at least one embodiment, system 1500 can include an external memory controller 1516 and platform controller hub 1530, which may be configured as a memory controller hub and peripheral controller hub within a system chipset that is in communication with processor(s) 1502.

Embodiments presented herein can manage one or more power cycle functions for a server tray or circuitry within a server tray using a timer-based circuit.

Various embodiments can be described by the following clauses:
1. A system, comprising:

at least one power source;

a timer circuit; and

circuitry to perform one or more logical operations, wherein in response to a receiving a power cycling command the timer circuit is triggered and power from the at least one power source is caused to no longer be available to the circuitry, and wherein after a set period of time the timer circuit generates a signal to cause power from the at least one power source to be made available to allow for resumed operation of the circuitry.
2. The system of clause 1, wherein the circuitry is contained in a server tray of a server rack, and wherein the power is caused to no longer be available to any of the circuitry in the server tray other than the timer circuit.
3. The system of clause 1, wherein the at least one power source includes at least one power busbar which receives power continuously during operation.
4. The system of clause 1, wherein the power cycling command is an instruction received from an external system, an instruction generated by a component of the circuitry, or a mechanical signal generated in response to manual activation of a physical activator connected to the server tray.
5. The system of clause 1, wherein the set period of time is sufficient to allow for discharge of at least a minimum amount of capacitance of the circuitry.
6. The system of clause 1, further comprising

a power management component to receive the power cycling command, trigger the timer circuit, and cause the power from the at least one power source to no longer be available to the circuitry.
7. The system of clause 1, wherein the timer circuit is allowed to generate multiple signals to allow for the power from the at least one power source to be made available to different portions of the circuitry at different points in time.
8. A method for power cycling a circuit in a server tray, comprising:

receiving a power cycling instruction;

triggering a timer circuit with respect to a specified period of time;

causing power from at least one power source to no longer be provided to the circuit, wherein all logic components of the circuit cease operation;

receiving, after passage of the specified period of time, a signal from the timer circuit; and

in response to receiving the signal, causing the power from the at least one power source to be provided to the circuit, wherein operation of all logic components of the circuit are allowed to resume operation.
9. The method of clause 8, further comprising

adjusting the circuit timer to set a time length as the specified period of time.
10. The method of clause 8, wherein the power is caused to no longer be available to any of the circuit in the server tray other than the timer circuit.
11. The method of clause 8, wherein the at least one power source includes at least one power busbar which receives power continuously during operation.
12. The method of clause 8, wherein the specified period of time is sufficient to allow for discharge of at least a minimum amount of capacitance of the circuit.
13. The method of clause 8, herein the timer circuit is allowed to generate multiple signals to allow for the power from the at least one power source to be made available to different portions of the circuit at different points in time.
14. The method of clause 8, further comprising:

determining, after the power is caused to be provided, that the power has not been provided to all logic components of the circuit; and

generating a subsequent power cycling instruction.
15. The method of clause 14, wherein the power has not been provided to all logic components of the circuit in a specified sequence.
16. A server tray, comprising:

a tray to receive processing circuitry;

at least one busbar to provide a continuous source of power; and

a timer circuit, wherein in response to a receiving a power cycling command the timer circuit is triggered and power from the at least one busbar is caused to no longer be provided to the processing circuitry, and wherein after a set period of time the timer circuit generates a signal to cause power from the at least one busbar to be provided to allow for resumed operation of the processing circuitry.
17. The server tray of clause 16, wherein the set period of time is sufficient to allow for discharge of at least a minimum amount of capacitance of the processing circuitry.
18. The server tray of clause 16, wherein the timer circuit is allowed to generate multiple signals to allow for the power from the at least one busbar to be made available to different portions of the processing circuitry at different points in time.
19. The server tray of clause 16, further comprising:

a power management component to receive the power cycling command, trigger the timer circuit, and cause the power from the at least one busbar to no longer be available to the processing circuitry.
20. The server tray of clause 16, wherein the server tray comprises at least one of:

a system for performing simulation operations;

a system for performing simulation operations to test or validate autonomous machine applications;

a system for performing digital twin operations;

a system for performing light transport simulation;

a system for rendering graphical output;

a system for performing deep learning operations;

a system for performing generative AI operations using a large language model (LLM);

a system implemented using an edge device;

a system for generating or presenting virtual reality (VR) content;

a system for generating or presenting augmented reality (AR) content;

a system for generating or presenting mixed reality (MR) content;

a system incorporating one or more Virtual Machines (VMs);

a system implemented at least partially in a data center;

a system for performing hardware testing using simulation;

a system for performing generative operations using a language model (LM);

a system for synthetic data generation;

collaborative content creation platform for 3D assets; or

a system implemented at least partially using cloud computing resources.

In at least one embodiment, a single semiconductor platform may refer to a sole unitary semiconductor-based integrated circuit or chip. In at least one embodiment, multi-chip modules may be used with increased connectivity which simulate on-chip operation, and make substantial improvements over using a conventional central processing unit (“CPU”) and bus implementation. In at least one embodiment, various modules may also be situated separately or in various combinations of semiconductor platforms per desires of user.

In at least one embodiment, referring back to FIG. 11, computer programs in form of machine-readable executable code or computer control logic algorithms are stored in main memory 1104 and/or secondary storage. Computer programs, if executed by one or more processors, enable computer system 1100 to perform various functions in accordance with at least one embodiment. In at least one embodiment, main memory 1104, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous FIGS. 1-7 are implemented in context of CPU 1102, parallel processing system 1112, an integrated circuit capable of at least a portion of capabilities of both CPU 1102, parallel processing system 1112, a chipset (e.g., a group of integrated circuits designed to work and sold as a unit for performing related functions, etc.), and/or any suitable combination of integrated circuit(s).

In at least one embodiment, architecture and/or functionality of various previous FIGS. 1-7 are implemented in context of a general computer system, a circuit board system, a game console system dedicated for entertainment purposes, an application-specific system, and more. In at least one embodiment, computer system 1100 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 1112 includes, without limitation, a plurality of parallel processing units (“PPUs”) 1114 and associated memories 1116. In at least one embodiment, PPUs 1114 are connected to a host processor or other peripheral devices via an interconnect 1118 and a switch 1120 or multiplexer. In at least one embodiment, parallel processing system 1112 distributes computational tasks across PPUs 1114 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 1114, although such shared memory may incur performance penalties relative to use of local memory and registers resident to a PPU 1114. In at least one embodiment, operation of PPUs 1114 is synchronized through use of a command such as _syncthreads( ), wherein all threads in a block (e.g., executed across multiple PPUs 1114) to reach a certain point of execution of code before proceeding.

In at least one embodiment, one or more techniques described herein use a oneAPI programming model. In at least one embodiment, a oneAPI programming model refers to a programming model for interacting with various compute accelerator architectures. In at least one embodiment, oneAPI refers to an application programming interface (API) designed to interact with various compute accelerator architectures. In at least one embodiment, a oneAPI programming model uses a DPC++ programming language. In at least one embodiment, a DPC++ programming language refers to a high-level language for data parallel programming productivity. In at least one embodiment, a DPC++ programming language is based at least in part on C and/or C++ programming languages. In at least one embodiment, a oneAPI programming model is a programming model such as those developed by Intel Corporation of Santa Clara, CA.

In at least one embodiment, oneAPI and/or oneAPI programming model is used to interact with various accelerator, GPU, processor, and/or variations thereof, architectures. In at least one embodiment, oneAPI includes a set of libraries that implement various functionalities. In at least one embodiment, one API includes at least a oneAPI DPC++ library, a oneAPI math kernel library, a oneAPI data analytics library, a oneAPI deep neural network library, a oneAPI collective communications library, a oneAPI threading building blocks library, a oneAPI video processing library, and/or variations thereof.

In at least one embodiment, a oneAPI DPC++ library, also referred to as oneDPL, is a library that implements algorithms and functions to accelerate DPC++ kernel programming. In at least one embodiment, oneDPL implements one or more standard template library (STL) functions. In at least one embodiment, oneDPL implements one or more parallel STL functions. In at least one embodiment, oneDPL provides a set of library classes and functions such as parallel algorithms, iterators, function object classes, range-based API, and/or variations thereof. In at least one embodiment, oneDPL implements one or more classes and/or functions of a C++ standard library. In at least one embodiment, oneDPL implements one or more random number generator functions.

In at least one embodiment, a oneAPI math kernel library, also referred to as oneMKL, is a library that implements various optimized and parallelized routines for various mathematical functions and/or operations. In at least one embodiment, oneMKL implements one or more basic linear algebra subprograms (BLAS) and/or linear algebra package (LAPACK) dense linear algebra routines. In at least one embodiment, oneMKL implements one or more sparse BLAS linear algebra routines. In at least one embodiment, oneMKL implements one or more random number generators (RNGs). In at least one embodiment, oneMKL implements one or more vector mathematics (VM) routines for mathematical operations on vectors. In at least one embodiment, oneMKL implements one or more Fast Fourier Transform (FFT) functions.

In at least one embodiment, a oneAPI data analytics library, also referred to as oneDAL, is a library that implements various data analysis applications and distributed computations. In at least one embodiment, oneDAL implements various algorithms for preprocessing, transformation, analysis, modeling, validation, and decision making for data analytics, in batch, online, and distributed processing modes of computation. In at least one embodiment, oneDAL implements various C++ and/or Java APIs and various connectors to one or more data sources. In at least one embodiment, oneDAL implements DPC++ API extensions to a traditional C++ interface and enables GPU usage for various algorithms.

In at least one embodiment, a oneAPI deep neural network library, also referred to as oneDNN, is a library that implements various deep learning functions. In at least one embodiment, oneDNN implements various neural network, machine learning, and deep learning functions, algorithms, and/or variations thereof.

In at least one embodiment, a oneAPI collective communications library, also referred to as oneCCL, is a library that implements various applications for deep learning and machine learning workloads. In at least one embodiment, oneCCL is built upon lower-level communication middleware, such as message passing interface (MPI) and libfabrics. In at least one embodiment, oneCCL enables a set of deep learning specific optimizations, such as prioritization, persistent operations, out of order executions, and/or variations thereof. In at least one embodiment, oneCCL implements various CPU and GPU functions.

In at least one embodiment, a oneAPI threading building blocks library, also referred to as oneTBB, is a library that implements various parallelized processes for various applications. In at least one embodiment, oneTBB is used for task-based, shared parallel programming on a host. In at least one embodiment, oneTBB implements generic parallel algorithms. In at least one embodiment, oneTBB implements concurrent containers. In at least one embodiment, oneTBB implements a scalable memory allocator. In at least one embodiment, oneTBB implements a work-stealing task scheduler. In at least one embodiment, oneTBB implements low-level synchronization primitives. In at least one embodiment, oneTBB is compiler-independent and usable on various processors, such as GPUs, PPUs, CPUs, and/or variations thereof.

In at least one embodiment, a oneAPI video processing library, also referred to as one VPL, is a library that is used for accelerating video processing in one or more applications. In at least one embodiment, one VPL implements various video decoding, encoding, and processing functions. In at least one embodiment, one VPL implements various functions for media pipelines on CPUs, GPUs, and other accelerators. In at least one embodiment, one VPL implements device discovery and selection in media centric and video analytics workloads. In at least one embodiment, one VPL implements API primitives for zero-copy buffer sharing.

In at least one embodiment, a oneAPI programming model uses a DPC++ programming language. In at least one embodiment, a DPC++ programming language is a programming language that includes, without limitation, functionally similar versions of CUDA mechanisms to define device code and distinguish between device code and host code. In at least one embodiment, a DPC++ programming language may include a subset of functionality of a CUDA programming language. In at least one embodiment, one or more CUDA programming model operations are performed using a oneAPI programming model using a DPC++ programming language.

In at least one embodiment, any application programming interface (API) described herein is compiled into one or more instructions, operations, or any other signal by a compiler, interpreter, or other software tool. In at least one embodiment, compilation comprises generating one or more machine-executable instructions, operations, or other signals from source code. In at least one embodiment, an API compiled into one or more instructions, operations, or other signals, when performed, causes one or more processors such as graphics processor 1410, graphics processor 1440, graphics core 1500, parallel processor 1700, graphics processor 1900, or any other logic circuit further described herein to perform one or more computing operations.

It should be noted that, while example embodiments described herein may relate to a CUDA programming model, techniques described herein can be used with any suitable programming model, such HIP, oneAPI, and/or variations thereof.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

1. A system, comprising:
at least one power source;
a timer circuit; and
circuitry to perform one or more logical operations, wherein in response to a receiving a power cycling command the timer circuit is triggered, beginning a set period of time, and in response to the triggered timer circuit power from the at least one power source is caused to no longer be available to the circuitry, and wherein after the set period of time the timer circuit generates a signal to cause power from the at least one power source to be made available to allow for resumed operation of the circuitry.

2. The system of claim 1, wherein the circuitry is contained in a server tray of a server rack, and wherein the power is caused to no longer be available to any circuits, including the circuitry, in the server tray other than the timer circuit.

3. The system of claim 1, wherein the at least one power source includes at least one power busbar which receives power continuously during operation.

4. The system of claim 1, wherein the power cycling command is an instruction received from an external system, an instruction generated by a component of the circuitry, or a mechanical signal generated in response to manual activation of a physical activator.

5. The system of claim 1, further comprising:
a baseboard management controller (BMC) of the circuitry connected to a trigger of the timer circuit; and
a switch between the at least one power source and the circuitry, wherein the BMC activates the trigger of the timer circuit according to the power cycling command to cause the timer to provide an output pulse to the switch to disconnect the at least one power source and the circuitry including the BMC.

6. The system of claim 1, further comprising:
a power management component to receive the power cycling command, trigger the timer circuit, and cause the power from the at least one power source to no longer be available to the circuitry.

7. The system of claim 1, wherein the timer circuit is allowed to generate multiple signals to allow for the power from the at least one power source to be made available to different portions of the circuitry at different points in time.

8. A method for power cycling a circuit in a server tray, comprising:
receiving a power cycling instruction;
triggering a timer circuit to start a timer with respect to a specified period of time;
in response to triggering the timer circuit, causing power from at least one power source to no longer be provided to the circuit, wherein all logic components of the circuit cease operation;
receiving, after passage of the specified period of time, a signal from the timer circuit; and
in response to receiving the signal, causing the power from the at least one power source to be provided to the circuit, wherein operation of all logic components of the circuit are allowed to resume operation.

9. The method of claim 8, further comprising:
adjusting the circuit timer to set a time length as the specified period of time.

10. The method of claim 8, wherein the power is caused to no longer be available to any circuitry, including the circuit, in the server tray other than the timer circuit.

11. The method of claim 8, wherein the at least one power source includes at least one power busbar which receives power continuously during operation.

12. The method of claim 8, wherein the specified period of time is sufficient to allow for discharge of at least a minimum amount of capacitance of the circuit.

13. The method of claim 8, further comprising:
activating, based on the power cycling instruction, a trigger of the timer circuit using a baseboard management controller (BMC) of the circuit;
sending an output pulse from the timer circuit to activate a switch between the at least one power source and the circuit; and
disconnect, using the activated switch, the at least one power source from the circuit including the BMC.

14. The method of claim 8, further comprising:
determining, after the power is caused to be provided, that the power has not been provided to all logic components of the circuit; and
generating a subsequent power cycling instruction.

15. The method of claim 14, wherein the power has not been provided to all logic components of the circuit in a specified sequence.

16. A server tray, comprising:
a tray to receive processing circuitry;
at least one busbar to provide a continuous source of power; and
a timer circuit, wherein in response to a receiving a power cycling command the timer circuit is triggered, beginning a set period of time, and in response to the triggered timer circuit power from the at least one busbar is caused to no longer be provided to the processing circuitry, and wherein after the set period of time the timer circuit generates a signal to cause power from the at least one busbar to be provided to allow for resumed operation of the processing circuitry.

17. The server tray of claim 16, wherein the set period of time is sufficient to allow for discharge of at least a minimum amount of capacitance of the processing circuitry.

18. The server tray of claim 16, wherein the timer circuit is allowed to generate multiple signals to allow for the power from the at least one busbar to be made available to different portions of the processing circuitry at different points in time.

19. The server tray of claim 16, further comprising:
a power management component to receive the power cycling command, trigger the timer circuit, and cause the power from the at least one busbar to no longer be available to the processing circuitry.

20. The server tray of claim 16, wherein the server tray comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources.
